(19) United States
(12) Patent Application Publication
(10) Pub. No.: US 2026/0029423 A1
(43) Pub. Date: Jan. 29, 2026

(54) HIGH-PRECISION AND HIGH SETBACK ACCELERATION RESISTANT RESERVE ACCELEROMETERS FOR MUNITIONS

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Ronkonkoma, NY (US)

(21) Appl. No.: 19/283,107

(22) Filed: Jul. 28, 2025

Related U.S. Application Data
(60) Provisional application No. 63/676,652, filed on Jul. 29, 2024.

(51) Int. Cl. G01P 15/08; F42C 15/24; G01P 15/125

(52) U.S. Cl. CPC G01P 15/0802; G01P 15/125; F42C 15/24

(57) ABSTRACT

An accelerometer including: a housing; a proof mass; a piezoelectric material; a support member for holding the proof mass a predetermined distance from the piezoelectric material, the proof mass being rotatably disposed relative to the housing and having a center of gravity offset from an axis of rotation of the support member; a first biasing material for biasing the proof mass towards the piezoelectric material and against the support member; and a second biasing material for biasing the proof mass at the predetermined distance from the piezoelectric material. When a level of acceleration of the proof mass is less than or equal to an acceleration level that is to be measured, the second biasing material is configured to force the support member to rotate to disengage the proof-mass and the first biasing material to move the proof-mass to contact the piezoelectric material.

### CROSS REFERENCE TO RELATED APPLICATION

This application claims the benefit of U.S. Provisional Application No. 63/676,668, filed on Jul. 29, 2024, the entire contents of which is incorporated herein by its reference.

### BACKGROUND OF THE INVENTION

### 1. Field of the Invention

The present invention relates generally to methods to design highly sensitive and high-precision accelerometers that can withstand initial high setback acceleration during munition firing while being inactive and activate following detection of the munition firing event, and more particularly to accelerometers for accurately measuring linear and rotary accelerations such as those experienced by munitions during firing.

### 2. Prior Art

When measuring mechanical vibrations or acceleration, the so-called seismic accelerometers employing piezoelectric material for generating the electrical charges are often used. In such accelerometers, seismic mass(s) and piezoelectric element(s) are arranged such that when the accelerometer is subjected to acceleration, the resulting inertial forces introduce strain in the piezoelectric element(s), which in turn produce electrical outputs by virtue of the piezoelectric effect.

Examples of piezoelectric accelerometer types are:
1. accelerometers of the compression type,
2. accelerometers of the “Ring shear” type,
3. accelerometers of the “Conical ring shear” type,
4. accelerometers of the “Delta Shear” type,
5. accelerometers of the “Planar Shear” type.

In piezoelectric-based accelerometers, when vibrations having a frequency which is substantially lower than the natural frequency of the total accelerometer system are acting upon the base of the accelerometer, the seismic mass is forced to follow the vibrations, thereby acting on the piezoelectric element(s) with a force which is proportional to the seismic mass and the acceleration. Thereby, the inertial force acting on the piezoelectric element generates electrical charges on the piezoelectric element and the charges are substantially proportional to the applied acceleration.

When the piezoelectric element is subjected to compression forces during vibration, the accelerometer is of the compression type, and when the piezoelectric element is subjected to shear forces during vibration, the accelerometer is of the shear type.

A compression type piezoelectric-based accelerometer is the simplest in its construction, but currently available compression type accelerometers cannot satisfy the requirements for use in munitions and other similar systems since they cannot simultaneously be designed to measure the very low acceleration levels that are required for their inertia-based guidance and control system and also survive very high setback acceleration levels.

As an example, from the accuracy point of view, the accelerometer might be required to measure acceleration with a precision that is better than 0.001 G, but must still be capable of withstanding setback accelerations that may be as high as 50,000 G.

It is appreciated by those skilled in the art that acceleration and deceleration can both be used to apply compressive load to the piezoelectric element of currently available compression type accelerometers by proper mounting of the accelerometer. In general, compression type accelerometers are designed to measure both acceleration and deceleration once mounted to the intended object. This is usually achieved by providing preloading springs to ensure that the piezoelectric element is not subjected to tensile loading as the direction of the object acceleration is changed. For this reason, hereinafter, the term acceleration is also intended to include deceleration and only the direction of acceleration of the object to which the accelerometer is attached is indicated.

In general, higher sensitivity can be obtained by an accelerometer that uses bending type piezoelectric elements. In such accelerometers, the inertia forces due to the acceleration of the seismic mass acts to bend a so-called “bender element”, which has a layer of an electric conductive material sandwiched between two layers of piezoelectric material that are polarized in their direction of thickness. Thus, when the bender element is bent due to the application of the said inertia forces, compressive stresses are generated in one of the two piezoelectric layers and tensile stresses are generated in the rother piezoelectric layer. When the length of the bender element is significantly larger than the thickness of the element, the electrical charges generated on each of the two piezoelectric layers will be larger than the charges obtained if the said inertia forces would have acted directly to compress or shear a piezoelectric element.

However, the disadvantage of piezoelectric bender element based accelerometers is that the piezoelectric material constitutes a major part of the mechanical construction of the device, which makes it difficult to optimize their construction to achieve high rigidity and high natural frequency. Accelerometers of this type are also sensitive to temperature transients since the electrodes are arranged on surfaces which are perpendicular to the axis of polarization.

In contrast to the compression type accelerometers, the shear type accelerometers, for which type of accelerometers the electrical signal is developed on surfaces parallel to the axis of polarization. Such accelerometers do not require preloading to measure acceleration and deceleration and also have a low dynamic temperature sensitivity.

In general, all current methods for the design of linear as well as rotary accelerometers using piezoelectric elements can either be designed to have high sensitivity in a small acceleration range. These methods would in general preclude the development of accelerometers that could very accurately measure a very wide range of acceleration accurately. This is the case for accelerometers that are designed based on piezoelectric elements as well as those that are designed based on MEMS and other available technologies.

It is appreciated by those skilled in the art that spin-stabilized munitions are fired by rifled barrels, thereby subjecting the munitions to very high rotary acceleration as well as aforementioned high linear setback and set-forward accelerations.

To significantly increase the precision of linear and rotary accelerometers for use in inertial navigation for munitions and other applications such as launched UAVs, UGVs, gravity-dropped weapons, gravity dropped glider and parachute based systems, and the like, it is essential that the accelerometer that are used be highly accurate over the range of acceleration that is experienced by the system using the inertial navigation system. For example, a linear accelerometer that is used in a guided munition may only be subjected to a maximum of 1-2 G acceleration but may be subjected to setback acceleration that could be over 30,000 G and to achieve navigational precision requirements, the accelerometer might be required to be capable of providing around 0.001 G or better precision over the entire length of the flight. In such applications, the only practical requirement for the design of an accelerometer is that it withstands the initial high-G launch acceleration.

It is appreciated by those skilled in the art that spin-stabilized munitions are fired by rifled barrels, thereby subjecting the munitions to very high rotary acceleration as well as aforementioned high linear setback and set-forward accelerations. Therefore, linear accelerometers must present minimal or negligible sensitivity to spin rate and acceleration.

It is, therefore, highly desirable to develop methods for the design of high precision linear and rotary accelerometers that are capable of withstanding very high G initial accelerations, such as linear and rotary (spin) acceleration due to firing or ejection or the like in munitions and related accelerometers that can measure linear and rotary acceleration very accurately following the initial high-G linear and rotary acceleration event.

It is also highly desirable to develop methods for the design of high precision linear and rotary accelerometers that are capable of withstanding very high G linear and rotary accelerations, and that would begin to measure such accelerations very accurately once such high G accelerations are within a prescribed range.

It is also highly desirable to develop methods for the design of high precision linear and rotary accelerometers that are capable of withstanding very high G linear and rotary accelerations and decelerations, and that would begin to measure such accelerations very accurately once such high-G accelerations are within a prescribed range.

### SUMMARY OF THE INVENTION

A need therefore exists for the development of novel methods to design linear accelerometers that are capable of withstanding initial high-G accelerations and that when they are subjected to a prescribed high-G acceleration level and its prescribed duration, the accelerometer would begin to measure acceleration, i.e., are activated to begin acceleration measurement, with very high precision. All such accelerometers are hereinafter referred to as “Reserve Linear Accelerometers” for those that are designed to measure linear acceleration and “Reserve Rotary Accelerometers” for those that are designed to measure linear acceleration.

A need also exists for linear accelerometers that are designed using the above methods. It is appreciated that the resulting accelerometers may be activated to begin acceleration measurement with high precision using inertial forces/torques that are generated due to the prescribed activation high-G acceleration and its duration or may be activated by certain powered actuation force or torque. Such linear accelerometers would therefore function as “Reserve Linear Accelerometers”.

A need also exists for the development of novel methods to design accelerometers and for resulting accelerometers for measuring linear acceleration in a prescribed direction with minimal cross-sensitivity to rotational accelerations about the said acceleration measurement direction and about directions perpendicular to the said acceleration measurement direction.

A need also exists for the development of novel methods to design rotary accelerometers that are capable of withstanding initial high-G accelerations and that when they are subjected to a prescribed high-G acceleration level and its prescribed duration, the accelerometer would begin to measure acceleration, i.e., are activated to begin rotary acceleration measurement, with very high precision. Such linear accelerometers would therefore function as “Reserve Linear Accelerometers”.

A need also exists for rotary accelerometers that are designed using the above methods. It is appreciated that the resulting rotary accelerometers may be activated to begin acceleration measurement with high precision using inertial forces/torques that are generated due to the prescribed activation high-G acceleration and its duration or may be activated by certain powered actuation force or torque.

It is therefore a principal object of this invention to provide methods to design reserve linear accelerometers that can be constructed for measuring linear acceleration in a prescribed direction with high precision once it has detected a prescribed activation acceleration level and its duration, and which would not activate even if the experience acceleration in the activation direction that is larger in level and its duration.

It is yet another principal object of this invention to provide methods to design reserve linear accelerometers that can be constructed for measuring linear acceleration with precision in a prescribed direction when subjected to the prescribed acceleration level and its duration while exhibiting minimal cross-sensitivity to accelerations in the directions perpendicular to the said prescribed measurement direction and to any rotational acceleration.

It is yet another principal object of this invention to provide methods to design reserve rotary accelerometers that can be constructed for measuring rotary acceleration in a prescribed direction with high precision once it has detected a prescribed activation acceleration level and its duration, and which would not activate even if the experience acceleration in the activation direction that is larger in level and its duration.

Accordingly, herein is described novel methods for the design of reserve linear accelerometers of several types for accurately measuring linear acceleration in a prescribed direction once it has detected a prescribed activation acceleration level and its duration, and which would not activate even if the experience acceleration in the activation direction that is larger in level and its duration.

Herein is also described novel methods for the design of reserve rotary accelerometers of several types for accurately measuring rotary acceleration once it has detected a prescribed activation acceleration level and its duration, and which would not activate even if the experience acceleration in the activation direction that is larger in level and its duration.

In addition, herein is also described novel reserve linear and reserve rotary accelerometers for accurately measuring linear and rotary accelerations once they have detected a prescribed activation acceleration level and its duration, and which would not activate even if the experience acceleration in the activation direction that is larger in level and its duration.

A need also exists for methods for the design of high precision linear and rotary accelerometers that are capable of withstanding very high-G linear and rotary accelerations and decelerations, and that would begin to measure such accelerations very accurately once such high-G accelerations are within a prescribed acceleration measuring range.

A need also exists for linear and rotary accelerometers that are designed using the above methods. It is appreciated that the resulting accelerometers may be activated to begin acceleration and deceleration measurement with high precision using inertial forces/torques that are generated due to the prescribed activation acceleration and its duration or may be activated by certain powered actuation force or torque.

It is therefore a principal object of this invention to provide methods to design reserve linear accelerometers that can be constructed for measuring linear acceleration in a prescribed direction with high precision once it has detected a prescribed activation acceleration level and its duration, and which would not activate even if the experience acceleration in the activation direction is larger in level and its duration.

### BRIEF DESCRIPTION OF THE DRAWINGS

These and other features, aspects, and advantages of the apparatus of the present invention will become better understood with regard to the following description, appended claims, and accompanying drawings where:

FIG. 1A illustrates the cross-sectional view of a piezoelectric-based compression type accelerometer of prior art.

FIG. 1B illustrates the cross-sectional view of a piezoelectric-based shear type accelerometer of prior art.

FIG. 1C illustrates the cross-sectional view C-C of FIG. 2 of the first embodiment of a high-accuracy piezoelectric-based linear reserve accelerometer of the present invention while the accelerometer is subjected to a high-G acceleration.

FIG. 2 illustrates the cross-sectional view A-A of FIG. 1C of the first embodiment of a high-accuracy piezoelectric-based linear reserve accelerometer of the present invention while the accelerometer is subjected to a high-G acceleration.

FIG. 3 illustrates the cross-sectional view B-B of FIG. 2 of the first embodiment of a high-accuracy piezoelectric-based linear reserve accelerometer of the present invention while the accelerometer is subjected to a high-G acceleration.

FIG. 4 illustrates he cross-sectional view B-B of FIG. 2 of the first embodiment of a high-accuracy piezoelectric-based linear reserve accelerometer of the present invention while the accelerometer is subjected to the acceleration range that is to be accurately measured.

FIG. 5 illustrates the cross-sectional view F-F of FIG. 6 of the second embodiment of a high-accuracy piezoelectric-based linear reserve accelerometer of the present invention before it is activated to begin accurate measurement of acceleration in the prescribed acceleration measuring range of low-G accelerations.

FIG. 6 illustrates the cross-sectional view D-D of FIG. 5 of the second embodiment of a high-accuracy piezoelectric-based linear reserve accelerometer of the present invention before it is activated to begin accurate measurement of acceleration in the prescribed acceleration measuring range of low-G acceleration.

FIG. 6A illustrates the view “V1” of FIG. 6 in which it is indicated by the arrow showing the activation mechanism components of the reserve accelerometer.

FIG. 6B illustrates the view “V1” of FIG. 6A following disengagement of the release member by counterclockwise rotation of the release link.

FIG. 6C illustrates the view “V2” of FIG. 6 following the engagement of the “high-G locking element” with the release link and preventing its counterclockwise rotation to activate the reserve accelerometer. Other components of the reserve accelerometer are not shown.

FIG. 7 illustrates the cross-sectional view E-E of FIG. 6 of the second embodiment of a high-accuracy piezoelectric-based linear reserve accelerometer of the present invention before it is activated to begin accurate measurement of acceleration in the prescribed acceleration measuring range of low-G acceleration.

FIG. 8 illustrates the cross-sectional view of FIG. 7 of the second embodiment of a high-accuracy piezoelectric-based linear reserve accelerometer after its activation to begin accurate measurement of acceleration in the prescribed range of low-G acceleration.

FIG. 9 illustrates the cross-sectional view of FIG. 7 of the second embodiment of a high-accuracy piezoelectric-based linear reserve accelerometer as it is subjected to a high-G acceleration and its activation has been prevented by the provided mechanism.

FIG. 10 illustrates the modified cross-sectional view of FIG. 7 of the third embodiment of the electrically activated high-accuracy piezoelectric-based linear reserve accelerometer of the present invention before it is activated to begin accurate measurement of acceleration in the prescribed acceleration measuring range of low-G acceleration.

FIG. 11 illustrates the modified cross-sectional view of FIG. 6 of the third embodiment of the electrically activated high-accuracy piezoelectric-based linear reserve accelerometer of the present invention before it is activated to begin accurate measurement of acceleration in the prescribed acceleration measuring range of low-G acceleration.

FIG. 12 illustrates the cross-sectional view of FIG. 10 of the third embodiment of the high-accuracy piezoelectric-based linear reserve accelerometer after it is electrically actuated activation to begin accurate measurement of acceleration in the prescribed range of low-G acceleration.

FIG. 13 illustrates the cross-sectional view of the fourth embodiment of a shear type piezoelectric-based reserve linear accelerometer of the present invention before it is activated to begin accurate measurement of acceleration in the prescribed acceleration measuring range of low-G acceleration.

FIG. 14 illustrates the cross-sectional view H-H of FIG. 13 of the fourth embodiment of the electrically activated high-accuracy shear type piezoelectric-based linear reserve accelerometer of the present invention before it is activated to begin accurate measurement of acceleration in the prescribed acceleration measuring range of low-G acceleration.

FIG. 15 illustrates the cross-sectional view K-K of FIG. 14 of the fourth embodiment of the electrically activated high-accuracy shear type piezoelectric-based linear reserve accelerometer of the present invention before it is activated to begin accurate measurement of acceleration in the prescribed acceleration measuring range of low-G acceleration.

FIG. 16 illustrates the cross-sectional view of FIG. 15 of the fourth embodiment of the electrically activated high-accuracy shear type piezoelectric-based linear reserve accelerometer of the present invention after it is activated to begin accurate measurement of acceleration in the prescribed range of low-G acceleration.

FIG. 17 illustrates the cross-sectional view L-L of FIG. 18 of the fifth embodiment of a shear type piezoelectric-based electrically activated reserve linear accelerometer of the present invention before it is activated to begin accurate measurement of acceleration in the prescribed acceleration measuring range of low-G accelerations.

FIG. 18 illustrates the cross-sectional view M-M of FIG. 17 of the fifth embodiment of the electrically activated high-accuracy shear type piezoelectric-based reserve linear accelerometer of the present invention before it is activated to begin accurate measurement of acceleration in the prescribed acceleration measuring range of low-G accelerations.

FIG. 19 illustrates the cross-sectional view of FIG. 18 of the fifth embodiment of the electrically activated high-accuracy shear type piezoelectric-based reserve linear accelerometer of the present invention after it is activated to begin accurate measurement of acceleration in the prescribed range of low-G accelerations.

FIG. 20 illustrates the partial cross-sectional view M2-M2 of FIG. 17 of the “V” shaped mating engagement of the proof-mass section groove with the mating section of the proof-mass release link.

FIG. 21 illustrates the structural model of the bending flexibility of the release link and proof-mass assembly in the pre-activation configuration of the reserve linear accelerometer of FIGS. 17-18.

FIG. 22 illustrates the cross-sectional view L2-L2 of FIG. 23 of the sixth embodiment of a longitudinal pressure type piezoelectric-based electrically activated reserve linear accelerometer of the present invention before it is activated to begin accurate measurement of acceleration in the prescribed acceleration measuring range of low-G accelerations.

FIG. 23 illustrates the cross-sectional view N-N of FIG. 22 of the sixth embodiment of the electrically activated high-accuracy longitudinal pressure type piezoelectric-based reserve linear accelerometer of the present invention before it is activated to begin accurate measurement of acceleration in the prescribed acceleration measuring range of low-G accelerations.

FIG. 24 illustrates the cross-sectional view of FIG. 23 of the sixth embodiment of the electrically activated high-accuracy longitudinal pressure type piezoelectric-based reserve linear accelerometer of the present invention after it is activated to begin accurate measurement of acceleration in the prescribed range of low-G accelerations.

FIG. 25 illustrates the partial cross-sectional view N2-N2 of FIG. 22 of the “V” shaped mating engagement of the proof-mass section groove with the mating section of the proof-mass release link.

FIG. 26 illustrates the structural model of the bending flexibility of the release link and proof-mass assembly in the pre-activation configuration of the reserve linear accelerometer of FIGS. 22-25.

FIG. 27 illustrates the cross-sectional view of the seventh embodiment of a resettable longitudinal pressure type piezoelectric-based electrically activated reserve linear accelerometer of the present invention before it is activated to begin accurate measurement of acceleration in the prescribed acceleration measuring range of low-G accelerations.

FIG. 28 illustrates the cross-sectional view of FIG. 27 of the seventh embodiment of the electrically activated high-accuracy longitudinal pressure type piezoelectric-based reserve linear accelerometer of the present invention after it is activated to begin accurate measurement of acceleration in the prescribed range of low-G accelerations.

FIG. 29 illustrates the structural model of the bending flexibility of the release member and proof-mass assembly in the pre-activation configuration of the reserve linear accelerometer of FIGS. 27-28.

FIG. 30 illustrates the cross-sectional view of the eighth embodiment of a resettable shear type piezoelectric-based electrically activated reserve linear accelerometer of the present invention before it is activated to begin accurate measurement of acceleration in the prescribed acceleration measuring range of low-G accelerations.

FIG. 31 illustrates the cross-sectional view of FIG. 30 of the eighth embodiment of the electrically activated high-accuracy shear type piezoelectric-based reserve linear accelerometer of the present invention after it is activated to begin accurate measurement of acceleration in the prescribed range of low-G accelerations.

FIG. 32 illustrates the structural model of the bending flexibility of the release member and proof-mass assembly in the pre-activation configuration of the reserve linear accelerometer of FIGS. 30-31.

FIG. 33 illustrates the cross-sectional view C1-C1 of FIG. 34 of the nineth embodiment of a high-accuracy shear type piezoelectric-based linear reserve accelerometer of the present invention while the accelerometer is subjected to a high-G acceleration.

FIG. 34 illustrates the cross-sectional view Al-Al of FIG. 33 of the nineth embodiment of a high-accuracy shear type piezoelectric-based linear reserve accelerometer of the present invention while the accelerometer is subjected to a high-G acceleration.

FIG. 35 illustrates the cross-sectional view B1-B1 of FIG. 34 of the nineth embodiment of a high-accuracy shear type piezoelectric-based linear reserve accelerometer of the present invention while the accelerometer is subjected to a high-G acceleration.

FIG. 36 illustrates the cross-sectional view of FIG. 35 of the nineth embodiment of the high-accuracy shear type piezoelectric-based linear reserve accelerometer of the present invention after it is activated to begin accurate measurement of acceleration in the prescribed range of low-G accelerations.

### DETAILED DESCRIPTION OF THE PREFERRED EMBODIMENT

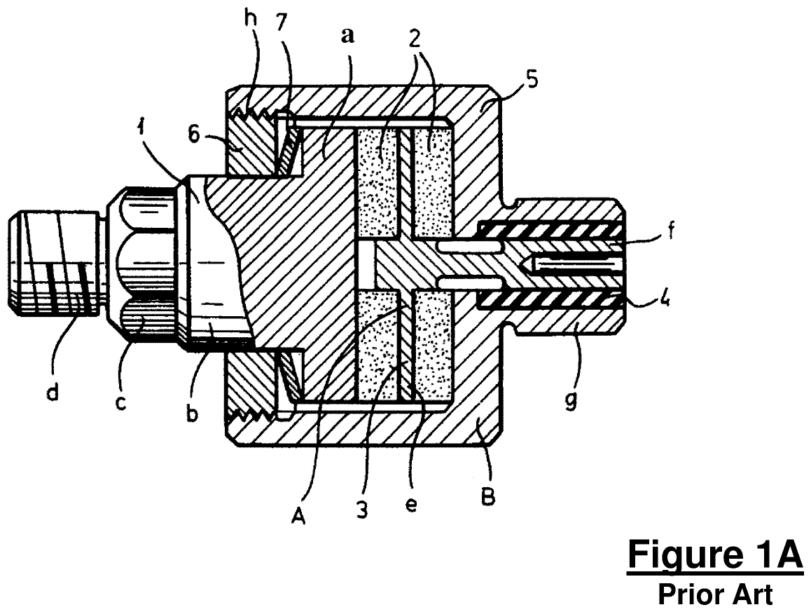

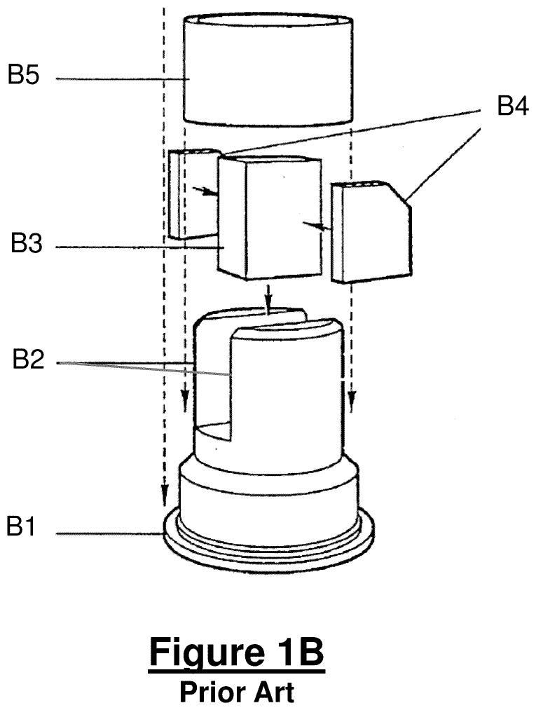

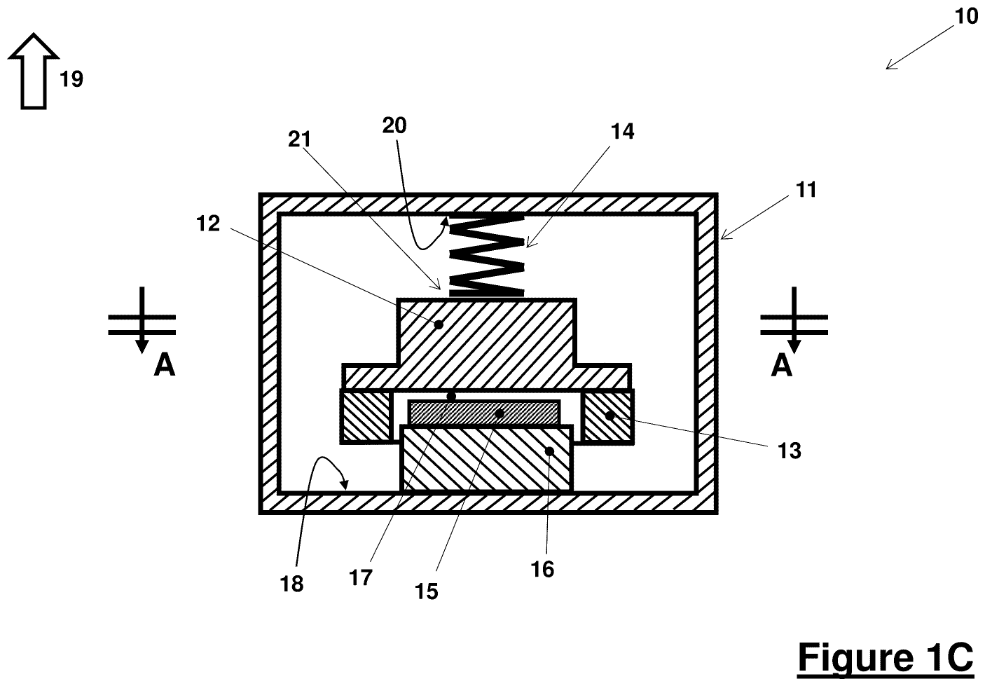

FIG. 1A shows the cross-sectional view of a typical piezoelectric-based compression type accelerometer (transducer) of prior art (U.S. Pat. No. 4,447,755). The accelerometer comprises a contact pin 1, formed with a disk a, braced by a connecting cylinder b, continued by a key hexagon c, provided with a threaded section d, being the purpose of fixing the accelerometer on the part (not shown) whose vibrations should be detected.

The suspension disk a of the pin 1 has one or more sensing elements A, made of a pair of piezoelectric rings 2 arranged with the faces of the same polarity on an intermediary disk e of a contact pin 3, provided with a terminal section f, which constitutes one of the two poles of the accelerometer.

The pin 3 is surrounded by an insulating sleeve 4 enclosed in the seismic mass B, having a threaded section g, which can be taken as the other pole and allows transducer connection for transmitting impulses generated by the piezoelectric rings 2.

At the opposite end, the cylindrical part 5 of the seismic mass B, is provided with an inner thread h, into which a gasket cover 6 is screwed engaging the contact pin 1.

Inside the casing 5, having the role of a seismic mass B, there is a preloaded spring disk 7 (Belleville washer) bracing disk a of the contact pin 1 against the seismic mass B.

The piezoelectric-based accelerometer has the following advantages:
simple construction, at low cost, with increased performances;
its weight is mostly the weight of the seismic mass, which is the active element, avoiding degradation of the vibrations to be detected.

Currently available compression type accelerometers, such as the one shown in FIG. 1A, have the problem of not being capable of withstanding high-G accelerations, such as those experienced in munitions or those that they may experience such accelerations accidentally or due to impacts experienced as being assembled or mounted in the intended system, or the like, before being required to accurately measure low-G accelerations, such as for guidance and control during the flight of a munition or UAV or the like.

In addition, currently available compression type accelerometers, such as the one shown in FIG. 1A, have the problem of not being capable of accurately measuring a wide range of accelerations. This is the case since the range of force that can be accurately measured by a single piezoelectric element is limited. For example, for a given piezoelectric element, by increasing the size of the seismic mass, the resulting accelerometer becomes more sensitive to acceleration, but the range of accelerations that can be measured is limited to the compressive strength of the piezoelectric element material. On the other hand, by using a smaller seismic mass the peak acceleration that can be measured is increased, but the accelerometer sensitivity is reduced. Thus, as expected for almost any sensor, accelerometer sensitivity and the level (peak) acceleration that can be measured compete with each other.

It is also appreciated by those skilled in the art that the above conclusion also applies to almost all other currently available linear and rotary accelerometers, including the shear type accelerometers, such as the following shear type accelerometer of the prior art shown in the schematic of FIG. 1B.

The basic design of a typical shear type accelerometer of the prior art (U.S. Pat. No. 5,572,081) is shown in the isometric view of FIG. 1B. The accelerometer consists of the seismic mass B3 and the piezoelectric elements B4, which are arranged between the uprights B2. The seismic mass B3 and the piezoelectric elements B4 are mounted between the two uprights B2 and clamped therebetween by means of a clamping ring B5. The uprights B2 may be formed directly in the base B1 as shown in FIG. 1B, or joined thereto by way of screwing, welding, soldering or the like. A plurality of pairs of piezoelectric elements B4, with one or more seismic masses B3 may be assembled between the two uprights B2.

The clamping ring B5 may be used for clamping the elements between the uprights B2 by pressing it in place, or by shrinking or other manners onto the outer side of the uprights B2. The elements may alternatively be secured by means of a screw connection through the said uprights, the piezoelectric elements, and the seismic mass, or by means of glue.

The piezoelectric elements B4 may be arranged with vertical and/or horizontal polarization directions, whereby the same accelerometer can register motion in several directions perpendicular to one another.

The accelerometer type of FIG. 1B is suited for measuring acceleration of linear movements, and the piezoelectric elements are mounted with their polarization directions parallel to the longitudinal axes of the uprights B2 or in three directions perpendicular to one another for measuring linear acceleration in those directions.

The accelerometer (body B1) is secured to the body, the acceleration of which is to be measured, and follows the movements of the body. As a result thereof, inertial forces arise between the uprights B2, the piezoelectric elements B4, and the seismic mass B3, proportional to the acceleration of the base B1.

The inertia forces generated by the acceleration in the axial (longitudinal) direction of the accelerometer cause a shear deformation of the piezoelectric elements, whereby an electric charge proportional to the acceleration is generated (when polarization directions of the piezoelectric elements B4 are parallel to the longitudinal axes of the uprights B2). This charge can then be measured by means of the associated electric equipment, usually as a voltage.

It is appreciated that the accelerometer can measure acceleration and deceleration in the axial direction of the object to which it is attached and generating charges of opposite voltages with each.

This shear type accelerometer with their polarization directions being parallel to the longitudinal axes of the uprights B2 become less sensitive to temperature transients as compared to other types of accelerometers.

Currently available shear type accelerometers, such as the one shown in FIG. 1B, also have the problem of not being capable of withstanding high-G accelerations, such as those experienced in munitions or those that they may experience such accelerations accidentally or due to impacts experienced as being assembled or mounted in the intended system, or the like, before being required to accurately measure low-G accelerations, such as for guidance and control during the flight of a munition or UAV or the like.

The methods of designing accelerometers that can withstand very high-G accelerations before being required to very accurately measure low-G accelerations are intended to provide such linear and rotary accelerometers. In these methods, the accelerometer proof-mass (seismic mass) is “isolated” from the accelerometer transducer, such as the piezoelectric elements provided in the above prior art accelerometers, and would only engage the transducer when it is required to very accurately measure low-G accelerations. Such accelerometers are thereby herein termed as “reserve” (linear or rotary) accelerometers.

Herein, the developed novel method for the piezoelectric-based “reserve linear accelerometers” that are capable of withstanding initial high-G accelerations and then provide very high accuracy acceleration measurement is described by a typical example of its implementation.

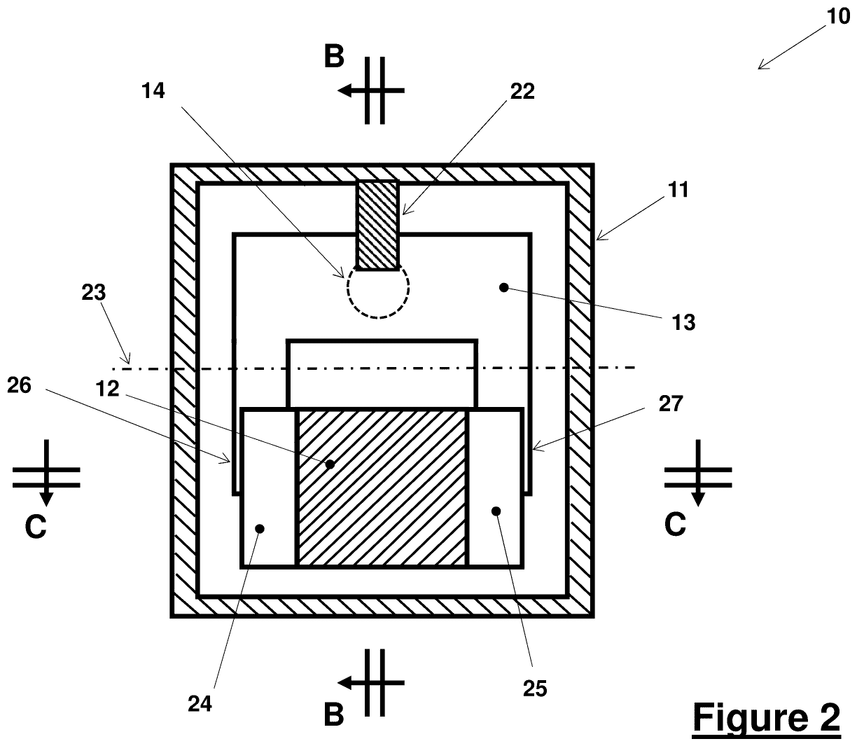

FIG. 1C illustrates the cross-sectional view C-C of FIG. 2 of the first embodiment of a high-accuracy piezoelectric-based reserve linear accelerometer of the present invention, which is hereinafter referred to as the “reserve linear accelerometer” embodiment 10. In the schematic of FIG. 1, the reserve linear accelerometer embodiment 10 is shown as it is subjected to a high-G acceleration in the direction of the arrow 19.

It is appreciated that the term high-G acceleration would hereinafter refer to applied accelerations (decelerations) in the direction of the acceleration (decelerations) to be measured by the reserve linear accelerometer, the level of which is above the peak acceleration (deceleration) level of the accelerometer prescribed “acceleration measuring range”.

As can be seen in FIG. 1, the reserve linear accelerometer embodiment 10 consists of a so-called “proof-mass” 12, which while the accelerometer is being subjected to a high-G acceleration level in the direction of the arrow 19, would be supported by the “High-G Support Member” 13, FIGS. 1C-3. As it is described later, when the reserve linear accelerometer embodiment 10 is subjected to a high-G acceleration in the direction of the arrow 19, the “high-G support member” 13 rises the proof-mass 12 up as viewed in the schematic of FIG. 1C to provide a gap 17 between the proof-mass and the piezoelectric member 15. It is noted that the piezoelectric member 15 serves as a transducer for measuring acceleration (deceleration) in the direction of arrow 19. In this configuration of the reserve linear accelerometer embodiment 10, the proof-mass 12 is biased against the surface of the “high-G support member” 13 by the preloaded compressive spring 14. The preloaded compressive spring 14 is fixed to the top surface of the proof-mass 12 on one end 21 and to the inside surface of the reserve linear accelerometer housing 11 on the other end 20. The piezoelectric member (transducer) 15 also is fixedly attached to the surface of a support member 16, which is in turn fixedly attached to the bottom surface 18 of the reserve linear accelerometer housing 11. The piezoelectric member (transducer) 15 is attached to the surface of the support member 16 using commonly used adhesives, usually an epoxy-based adhesive.

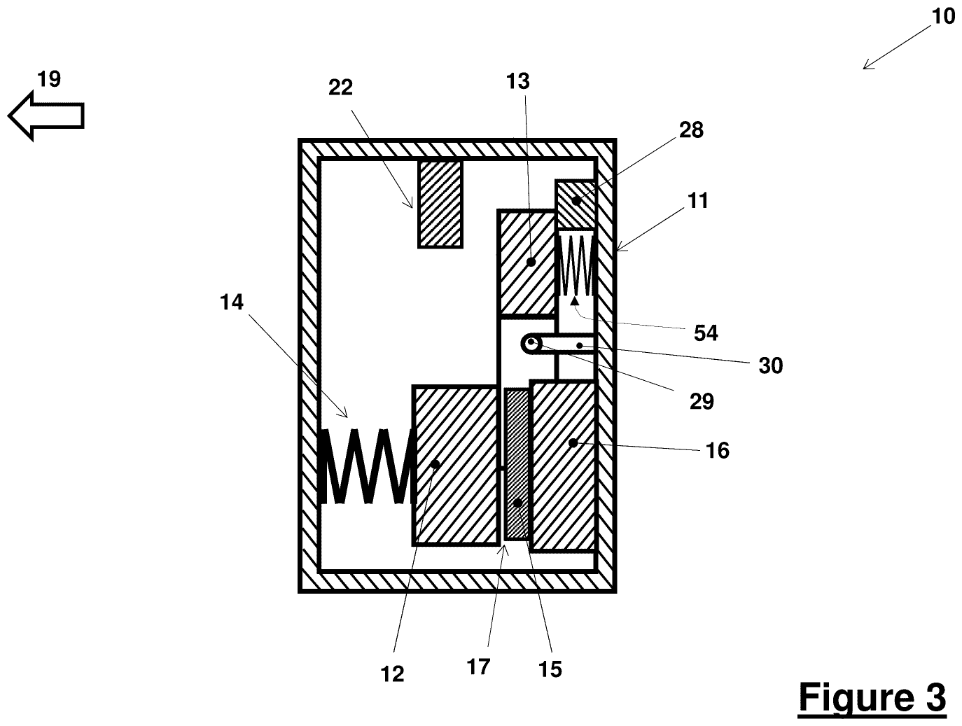

FIG. 2 shows the cross-sectional view A-A of FIG. 1C. As can be seen in FIG. 2, the “high-G support member” 13 is U-shaped with the sides 26 and 27 providing the means of supporting the sides 24 and 25 of the proof-mass 12, respectively, when the reserve linear accelerometer embodiment 10 is subjected to high-G accelerations as described later. The “high-G support member” 13 is attached to the housing 11 of the reserve linear accelerometer via a rotary joint 29, FIG. 3, with the shaft of the rotary joint passing from the side 26 of the “high-G support member” 13 to the side 27 being shown in the schematic of FIG. 2 by the centerline 23.

FIG. 3 shows the cross-sectional view B-B of FIG. 2. As can be seen in FIG. 3, the “high-G support member” 13 is attached to the base surface 18, FIG. 1C, of the reserve linear accelerometer housing 11 by a rotary joint 29, via the support member 30. The reserve linear accelerometer embodiment 10 is also provided with the stop members 22 and 28, which are configured to limit counterclockwise and clockwise rotations, respectively, of the “high-G support member” 13, FIG. 3. As can also be seen in the schematic of FIG. 3, in the illustrated configuration in which further clockwise rotation of the “high-G support member” 13 is prevented by the stop member 28, the proof-mass 12 is raised a small distance above the surface of the piezoelectric member 15 by the sides 26 and 27, FIG. 2, of the U-shaped “high-G support member” 13, thereby providing a small gap 17 between the proof-mass 12 and the piezoelectric member 15.

The reserve linear accelerometer embodiment 10 of FIGS. 1-3 would then function as follows, noting that in these illustrations, the reserve accelerometer is shown in the condition at which it is subjected to high-G acceleration in the direction of the arrow 19, which is defined as acceleration levels that are greater than the range of acceleration levels that the accelerometer is configured to accurately measure, which is hereinafter referred to as the “acceleration measuring range”. It is also noted that hereinafter, the term acceleration is intended to be used whether its magnitude is positive or negative, i.e., whether it indicates a positive or negative acceleration, i.e., whether it indicates acceleration or deceleration.

Now while the object to which the reserve linear accelerometer embodiment 10 is attached is being accelerated in the direction of the arrow 19, FIGS. 1 and 3, the acceleration acts on the “high-G support member” 13, the center of mass of which is configured to be above the rotary joint 29 as viewed in the plane of FIG. 3, thereby generating a clockwise inertial torque that would tend to rotate the “high-G support member” 13 in the clockwise direction.

In the configuration of the reserve linear accelerometer shown in FIGS. 1-3, the level of the applied high-G acceleration in the direction of the arrow 19 is greater than the peak acceleration of the prescribed “acceleration measuring range”, and the “high-G support member” 13 and the preloaded compressive spring 54 are configured such that the generated clockwise inertial torque that is applied to the “high-G support member” 13 would overcome the preloading level of the preloaded compressive spring 54 and the combine force of the preloaded compressive spring 14 and the generated inertial force of the proof-mass 12. As a result, the clockwise rotation of the “high-G support member” 13 would cause its U-shaped sides 26 and 27 to raise the proof-mass 12 above the piezoelectric member 15 until its clockwise rotation is stopped by stop 28, leaving a gap 17 between proof-mass 12 and the piezoelectric member 15 as shown in FIG. 3.

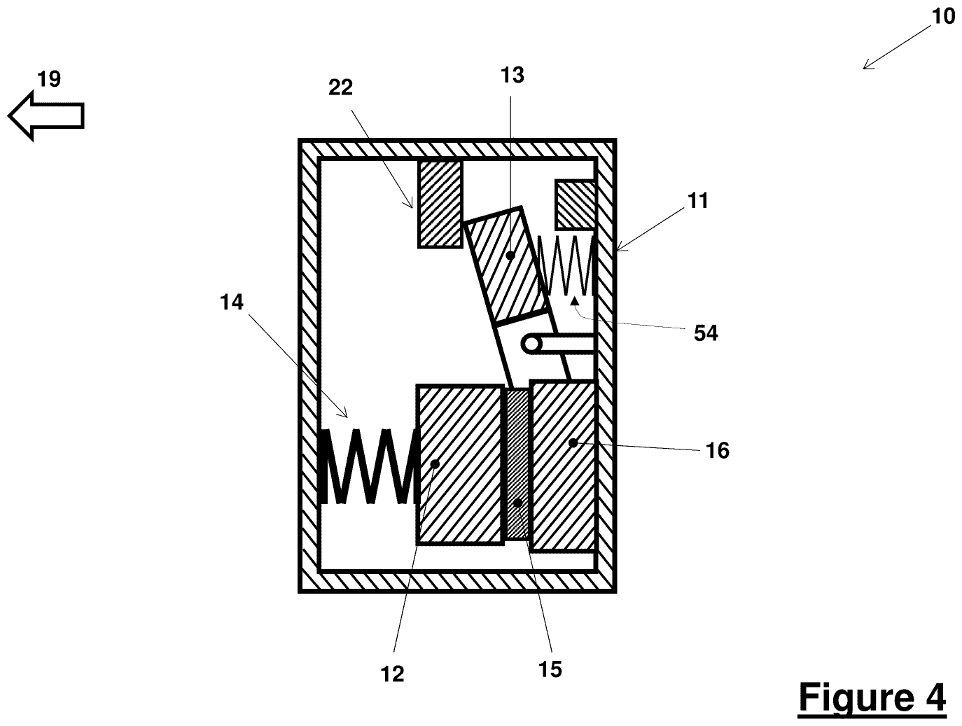

However, if the level of acceleration in the direction of the arrow 19 is less than or equal to the acceleration level that the accelerometer is configured to accurately measure, i.e., if it is less than or equal to the peak level of the “accelerometer measuring range”, then the preloaded compressive spring 54 is configured to force the “high-G support member” 13 to rotate in the counterclockwise direction, thereby causing the “high-G support member” 13 to disengage the proof-mass 12 as shown in the schematic of FIG. 4, resulting in the proof-mass 12 to be positioned over the surface of the piezoelectric member 15 by the preloaded compressive spring 14. The counterclockwise rotation of the “high-G support member” 13 is limited by stop 22, FIG. 4.

It is appreciated by those skilled in the art that the aforementioned “accelerometer measuring range” is intended to cover positive and negative acceleration in the direction of the arrow 19, i.e., both acceleration and deceleration in the direction of the arrow 19.

It is appreciated that the preloading level of the preloaded compressive spring 14 is usually selected so that the piezoelectric member 15 is under compression in normal (no acceleration) conditions, so that the reserve linear accelerometer embodiment 10 could measure acceleration as well as deceleration in the direction of the arrow 19.

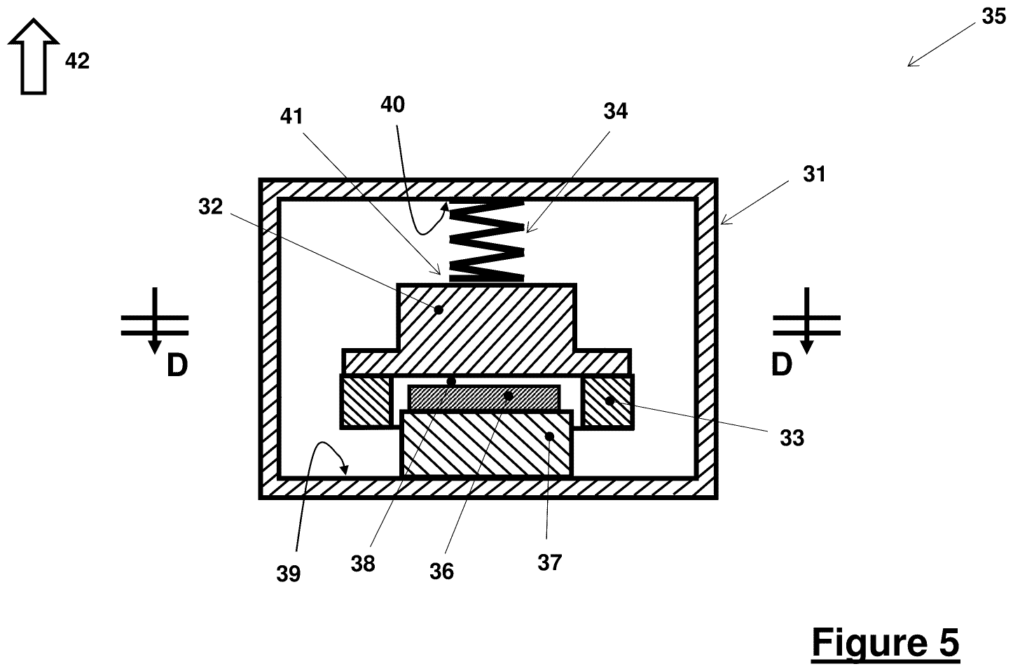

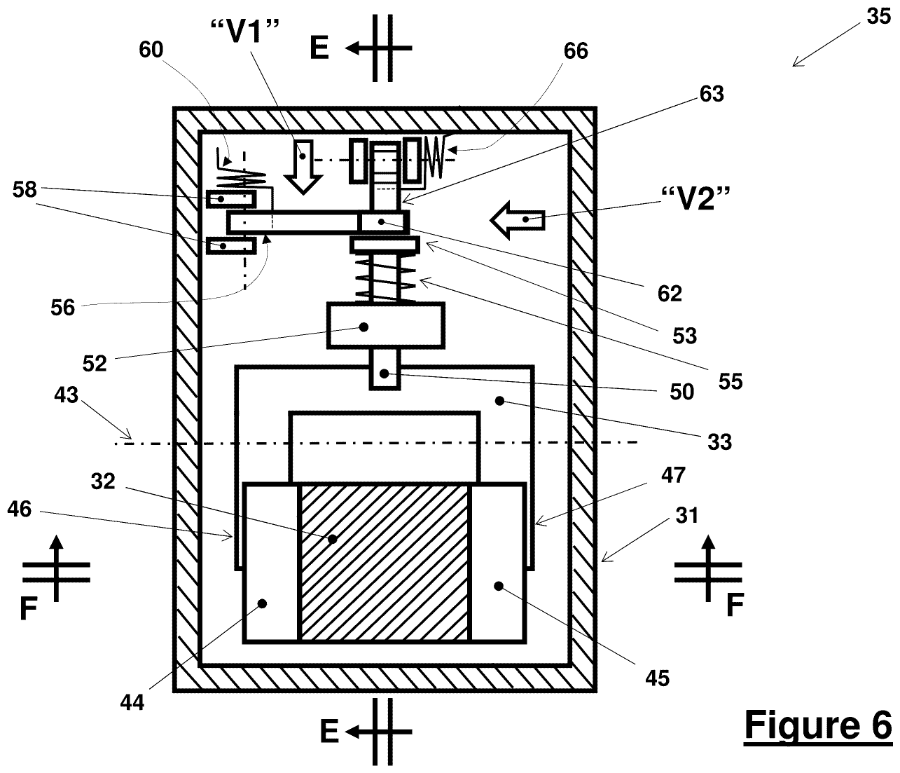

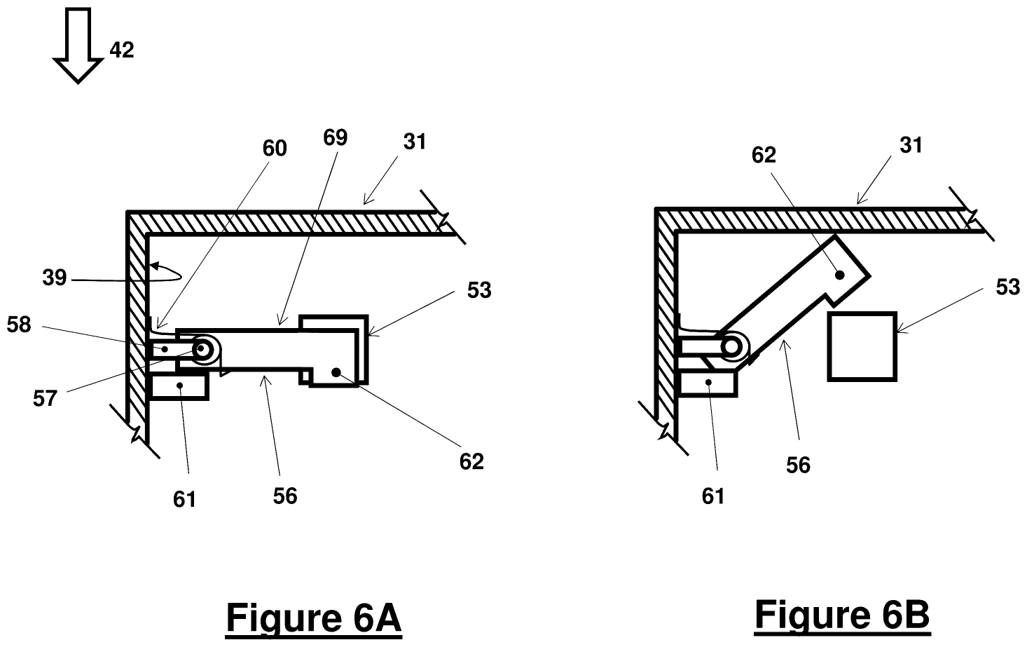

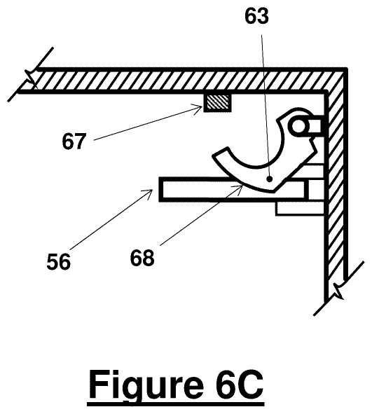

FIG. 5 illustrates the cross-sectional view F-F of FIG. 6 of the second embodiment of a high-accuracy piezoelectric-based “reserve linear accelerometer”, indicated as embodiment 35. This embodiment is configured to be activated only if the reserve linear accelerometer is subjected to the prescribed “acceleration measuring range”.

In the schematic of FIG. 5, the reserve linear accelerometer embodiment 35 is shown in its configuration before it is activated by a high-G acceleration to begin accurate measurement of acceleration in the prescribed range of low-G acceleration.

As can be seen in FIG. 5, the reserve linear accelerometer embodiment 35 consists of a so-called “proof-mass” 32, which is being supported by the “high-G support member” 33, FIGS. 5-7. The “high-G support member” 33 is held in this proof-mass support positioning as described later, such that the proof-mass 32 is positioned a very small distance, preferably around 0.001″-0.002″, above the surface of the piezoelectric member 36, providing a gap 38 between the proof-mass and the piezoelectric member. It is noted that piezoelectric member 15 serves as a transducer for measuring acceleration in the direction of arrow 42. In this configuration of the reserve linear accelerometer embodiment 35, the proof-mass 32 is biased against the surface of the “high-G support member” 33 by the preloaded compressive spring 34. The preloaded compressive spring 34 is fixed to the top surface of the proof-mass 32 on one end 41 and to the inside surface of the reserve linear accelerometer housing 31 on the other end 40. The piezoelectric member (transducer) 36 also is fixedly attached to the surface of a support member 37, which is in turn fixedly attached to the bottom surface 39 of the reserve linear accelerometer housing 31. The piezoelectric member (transducer) 32 is attached to the surface of the support member 37 using commonly used adhesives, usually an epoxy-based adhesive.

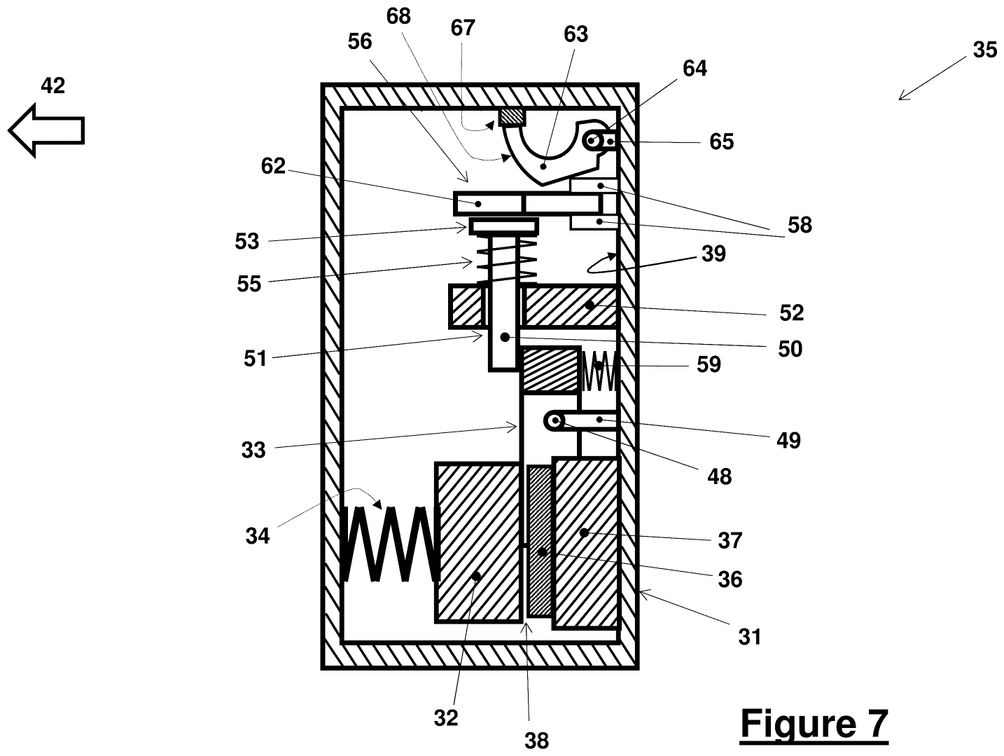

FIG. 6 shows the cross-sectional view D-D of FIG. 5. As can be seen in FIG. 6, the “high-G support member” 33 is U-shaped with the sides 46 and 47 providing the means of supporting the sides 44 and 45 of the proof-mass 32, respectively, in the illustrated pre-activation state of the linear accelerometer embodiment 35. The “high-G support member” 33 is attached to the housing 31 of the reserve linear accelerometer via a rotary joint 48, FIG. 7, with the shaft of the rotary joint passing from the side 46 of the “high-G support member” 33 to the side 47 being shown in the schematic of FIG. 6 by the centerline 43.

FIG. 7 shows the cross-sectional view E-E of FIG. 6. The view “VI” of FIG. 6 is shown in FIG. 6A. As can be seen in FIG. 7, the “high-G support member” 33 is attached to the base surface 39 of the reserve linear accelerometer housing 31 by a rotary joint 48, via the support member 49. As can be seen in the schematic of FIG. 7, the “high-G support member” 33 is held in its present position by the preloaded compressive spring 59 biasing it against release member 50. The release member 50 is free to slide in a guide 51 that is provided in the support member 52, which is fixedly attached to the bottom surface 39 of the reserve accelerometer housing 31. The release member 50 is provided with an end piece 53, between which and the support member 52 is positioned a preloaded compressive spring 55. The preloaded compressive spring 55 is used to bias the end piece 53 against the release link 56, FIGS. 6, 6A, and 7 in the pre-activation state of the reserve accelerometer shown in these illustrations. The release link 56 is attached to the surface 39 of the reserve accelerometer housing 31, FIGS. 6, 6A and 7, by the rotary joint 57, FIG. 6A, via the supports 58, FIGS. 6, 6A and 7. Also as can be seen in FIG. 6A, the release link 56 is also provided with a preloaded torsion spring 60, which acts about the rotary joint 57 and is attached to the release link 56 on one end and to the surface 39 of the reserve accelerometer housing 31 on the other end. In the pre-activation configuration of the reserve accelerometer, release link 56 is biased against the stop member 61 as shown in FIG. 6A. In this configuration of the release link 56, its larger end section 62, FIG. 6A, is in the path upward displacement of the end piece 53 and thereby the release member 50 that would otherwise occur by the force of the preloaded compressive spring 55.

The reserve acceleration embodiment 35 is also provided with a “high-G locking element” 63, FIG. 7, which is attached to the bottom surface 39 of the reserve accelerometer housing 31 by the rotary joint 64 via the support member 65. As can also be seen in FIG. 6, the high-G locking element 63 is also provided with a preloaded torsion spring 66, which acts about the rotary joint 64 to bias the high-G locking element against to stop member 67, which is fixedly attached to the inner surface of the reserve accelerometer housing 31.

It is appreciated by those skilled in the art that in practice, a relatively soft spring element together with a parallelly paired damping material is preferably positioned in the gaps 17 and 38 of FIGS. 3 and 7, respectively, and also in all such disclosed embodiments, to prevent an impacting action as the reserve linear accelerometer is activated by a sudden high-G acceleration event.

The reserve linear accelerometer embodiment 35 of FIGS. 5-7 would then function as follows. When the object to which the reserve linear accelerometer embodiment 35 is attached is accelerated in the direction of the arrow 42, FIGS. 5 and 7, the acceleration acts on the “high-G support member” 33, the center of mass of which is designed to be below the rotary joint 48 as viewed in the plane of FIG. 7, thereby generating a counterclockwise inertial torque that would tend to rotate the “high-G support member” 33 in the counterclockwise direction.

The acceleration in the direction of the arrow 42 would also act on the release link 56, FIGS. 6A and 7, the center of mass of which is located to the right of its rotary joint 57 as viewed in FIG. 6A, thereby applying an inertial counterclockwise torque that tends to rotate it in the counterclockwise direction in the opposite direction of the preloading torque of the preloaded torsion spring 60.

The acceleration in the direction of the arrow 42 would also act on the “high-G lock member” 63, FIGS. 7 and 6, which is used to prevent reserve accelerometer activation when it is subjected to accelerations that are above the prescribed “accelerometer measuring range”. The center of mass of the “high-G lock member” 63 is below the rotary joint 64 as can be viewed in FIG. 7, thereby the applied acceleration would apply an inertial counterclockwise torque that tends to rotate the “high-G lock member” in the counterclockwise direction in the opposite direction of the preloading torque of the preloaded torsion spring 66, FIG. 6.

Now if the level of the applied acceleration in the direction of the arrow 42 is at or lower than peak acceleration of the aforementioned prescribed “accelerometer measuring range”, then the preloading level of the torsion spring 60 is selected such that it would allow the release link 56 to rotate in the counterclockwise direction as viewed in FIG. 6A due to the aforementioned inertial torque and at some point the section 62 of the release link 56 would disengage the end piece 53 of the release member 50 as shown in FIG. 6B.

In the meantime, the preloading level of the torsion spring 66, FIG. 6 is selected such that the generated counterclockwise inertial torque acting on the “high-G locking element” 63, FIG. 7, could not overcome the preloading of the torsion spring 66 and the “high-G locking element” would thereby stay stationary.

As a result, the preloaded compressive spring 55, FIG. 7, would force the release member 50 to slide back away from the “high-G support member” 33 and thereby disengage from it.

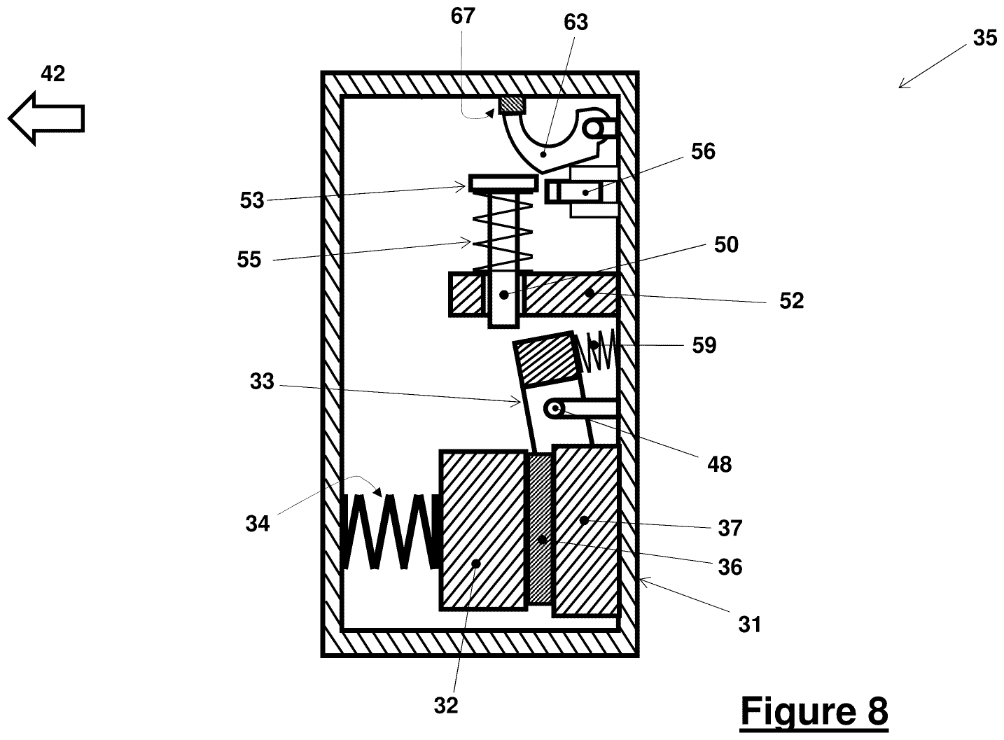

As a result, the “high-G support member” 33 is set free to rotate in the counterclockwise direction by the preloaded compressive spring 59 as viewed in the schematic of FIG. 7, and since its center of mass is located below its rotary joint 48, FIG. 7, further counterclockwise inertial torque is also applied to the “high-G support member” to assist its counterclockwise rotation as shown in the schematic of FIG. 8. The preloaded compressive spring 34 would then displace the proof-mass 32 towards the piezoelectric member 36 and close the gap 38, FIG. 8, thereby positioning the proof-mass over the surface of the piezoelectric member 36 and applying a compressive load to the piezoelectric member 36.

It is appreciated that the preloading level of the preloaded compressive spring 34 is usually selected such that the piezoelectric member 36 is under compression in normal (no acceleration) conditions, so that the reserve linear accelerometer embodiment 35 could measure acceleration as well as deceleration in the direction of the arrow 42.

Now if the level of the applied acceleration in the direction of the arrow 42 is above the aforementioned prescribed “accelerometer measuring range”, then the counterclockwise inertial torque (as viewed in FIG. 6A) applied to the release link 56 due to the applied acceleration would overcome the preloading of the torsion spring 60 and the release link would begin to rotate in the counterclockwise direction as viewed in the schematic of FIG. 6A. However, in the meantime, the preloading level of the torsion spring 66, FIG. 6 is selected such that the generated inertial torque acting on the “high-G locking element” 63, FIG. 7, would overcome the preloading of the torsion spring 66 and the “high-G locking element” 63 would also begin to rotate in the counterclockwise direction as viewed in the schematic of FIG. 7. The surface 68 of the “high-G locking element” 63, FIG. 7, is however positioned very close to the bottom surface 69, FIG. 6A, of the release link 56. As a result, very quickly the surface 68 of the “high-G locking element” 63 is positioned under the bottom surface 69 of the release link 56 and prevent it to rotate in the counterclockwise direction enough to disengage the end piece 53 of the release member 50 as shown in the view “V2” of FIG. 6 that is illustrated in FIG. 6C, noting that in this illustration, the “high-G locking element” 63 and the release link 56 are only shown.

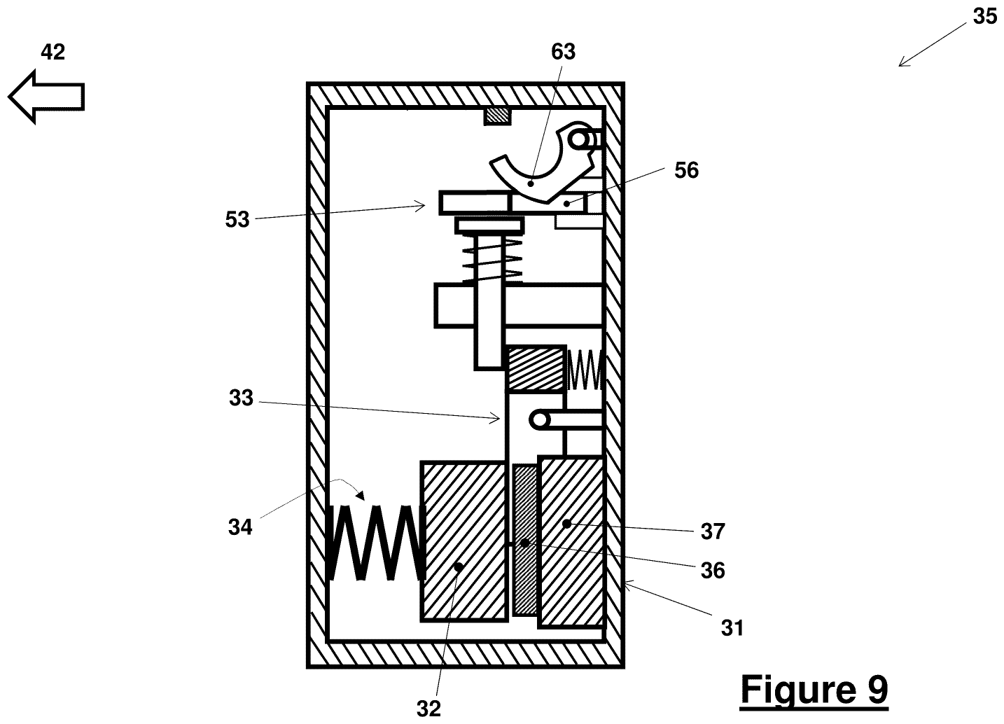

As a result, if the level of the applied acceleration in the direction of the arrow 42 is above the aforementioned prescribed “accelerometer measuring range”, then the reserve accelerometer embodiment 35 of FIGS. 5-9 is not activated, which means that the piezoelectric member (transducer) of the reserve accelerometer is not subjected to high compressive (tensile) force by the applied acceleration (deceleration) in the direction of the arrow 42, FIG. 9, acting on the proof-mass 32 of the reserve accelerometer.

As a result, the proof-mass of the reserve accelerometer may be designed with relatively large mass, thereby allowing the reserve accelerometer to measure acceleration in the direction of the arrow 42 in the prescribed range of low-G acceleration with very high accuracy.

It is appreciated by those skilled in the art that once the applied high-G acceleration, which is above the prescribed “accelerometer measuring range”, FIG. 9, has ceased, the preloaded torsion springs 66 and 60 of the “high-G locking element” 63 and the release link 56, respectively, FIG. 6, would return them to their initial positioning, i.e., the reserve accelerometer embodiment 35 of FIGS. 5-9 is reset.

It is appreciated by those skilled in the art that in applications such as those in gun-fired munitions, the munition and thereby all its components, including its reserve accelerometer, would be subjected to high-G setback acceleration as well as smaller but considerable set-forward acceleration (i.e., acceleration in the opposite direction of the setback acceleration), which could also be well above the low-G “accelerometer measuring range”, during which reserve accelerometer activation must also be prevented.

It is, however, appreciated by those skilled in the art that when the reserve accelerometer embodiment 35 of FIGS. 5-9 is subjected to a deceleration in the direction of the arrow 42, as can be seen in the view “V1” of FIG. 6, shown in the schematic of FIG. 6A, the deceleration act at the center of mass of the release link 56 and apply a clockwise inertial torque to the release link 56. However, as can be seen in FIG. 6A, the release link 56 is prevented from clockwise rotation by the stop member 61. As a result, the release member 50, FIG. 6, would not be released and the reserve accelerometer would not activate.

As a result, the reserve accelerometer embodiment 35 of FIGS. 5-9 would not be activated if subjected to high-G acceleration or deceleration events that have amplitudes beyond the prescribed “accelerometer measuring range”.

It is appreciated that in many applications, the object/system that is provided with a reserve linear accelerometer would have a source of electrical power, such as a battery. This is also mostly the case in munitions since they are usually powered by reserve power sources that are activated upon launch the provided electrical power is required for the system guidance and control units to be able to use the projectile acceleration that is measured by the provided reserve linear accelerometers.

For these applications, since electrical power is already available when the reserve linear accelerometer is desired to be activated, a reserve linear accelerometer that is activated by an electrically actuated mechanism may also be suitable or in some case preferable, particularly when the “accelerometer measuring range” is desirable to be adjustable depending on the environmental conditions and/or the conditions of the system use. The method of designing such electrically activated reserve linear accelerometers is herein described by the following example of its application, which is indicated as the third “reserve linear accelerometer” embodiment 70 of the present invention.

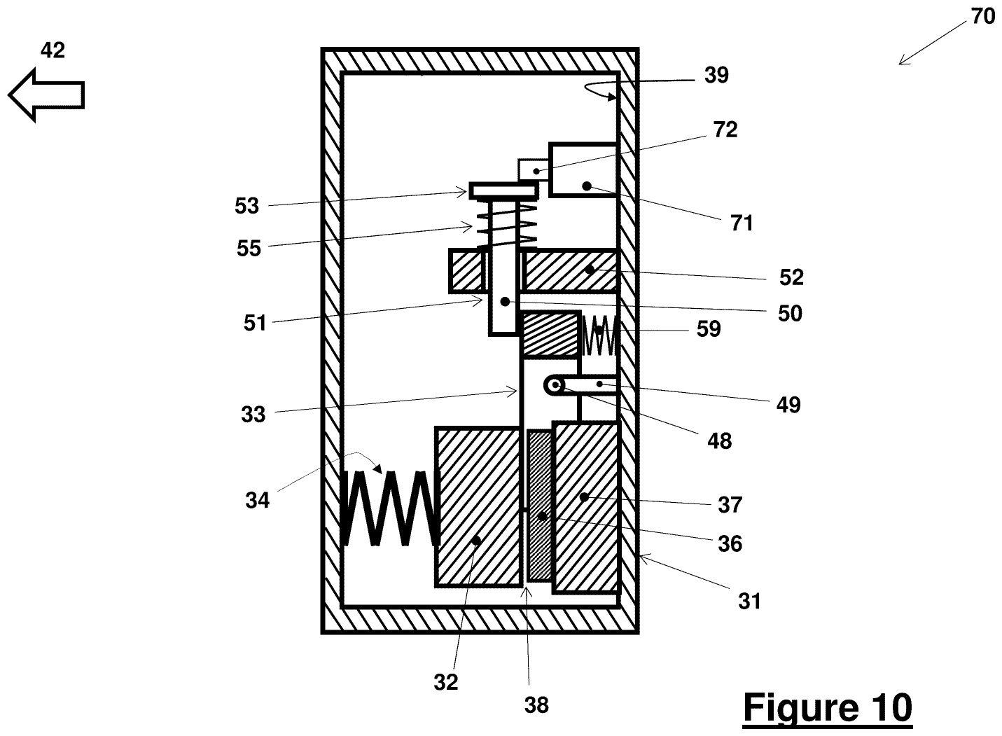

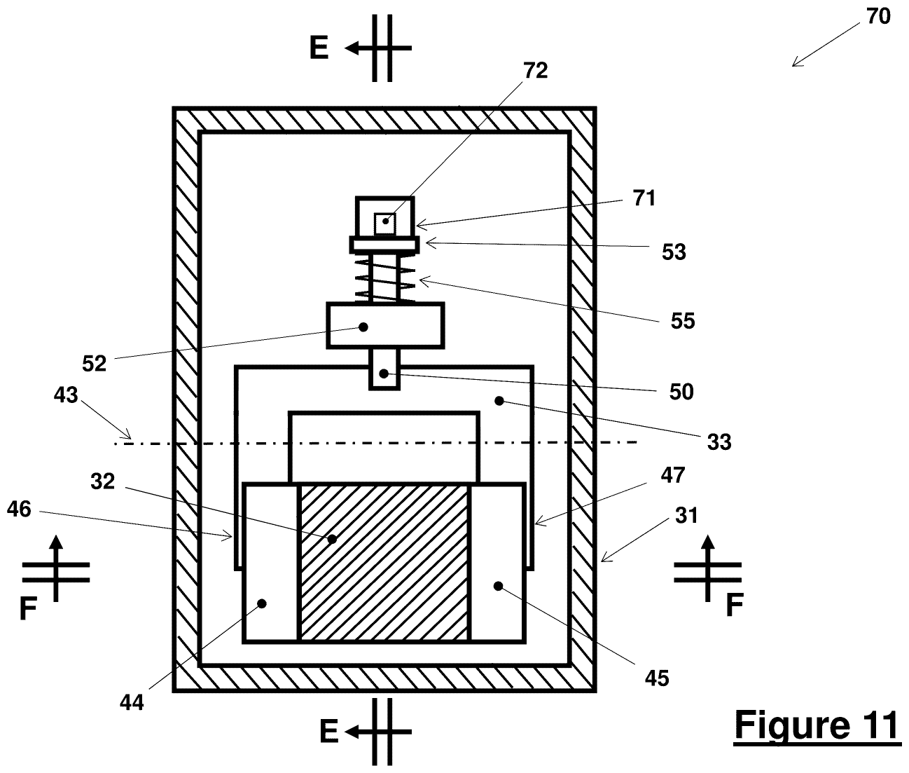

FIG. 10 shows the modified cross-sectional view of the reserve linear accelerometer embodiment 35 of FIG. 7, which illustrates the cross-sectional E-E of FIG. 11 (FIG. 6 in the reserve linear accelerometer embodiment 35) of the third reserve linear accelerometer embodiment 70 of the present invention. In the schematics of FIGS. 10 and 11, the reserve linear accelerometer embodiment 70 is shown in its configuration before being activated to begin accurate measurement of acceleration in its prescribed acceleration measuring range of low-G accelerations. This embodiment of the present invention is designed to be activated only if the reserve linear accelerometer is subjected to the prescribed “acceleration measuring range”.

FIG. 10 shows the cross-sectional view E-E of FIG. 11. As can be seen in FIG. 10, the “high-G support member” 33 is also attached to the base surface 39 of the reserve linear accelerometer housing 31 by a rotary joint 48, via the support member 49. As can be seen in the schematic of FIG. 7, the “high-G support member” 33 is held in its present position by the preloaded compressive spring 59 biasing it against release member 50. The release member 50 is free to slide in a guide 51 that is provided in the support member 52, which is fixedly attached to the bottom surface 39 of the reserve accelerometer housing 31. The release member 50 is provided with an end piece 53, between which and the support member 52 is positioned a preloaded compressive spring 55. The preloaded compressive spring 55 is used to bias the end piece 53 against the sliding piston 72 of the solenoid 71. The solenoid 71 body is fixedly attached to the base surface 39 of the reserve linear accelerometer housing 31.

FIG. 11 shows the cross-sectional view D-D of FIG. 5 shown in FIG. 6, with the modifications of the third reserve linear accelerometer 70 for activation by an electrical actuator. As can also be seen in FIG. 11, the “high-G support member” 33 is U-shaped with the sides 46 and 47 providing the means of supporting the sides 44 and 45 of the proof-mass 32, respectively, in the illustrated pre-activation state of the linear accelerometer embodiment 70. The “high-G support member” 33 is attached to the housing 31 of the reserve linear accelerometer via a rotary joint 48, FIG. 10, with the shaft of the rotary joint passing from the side 46 of the “high-G support member” 33 to the side 47 being shown in the schematic of FIG. 11 by the centerline 43.

It is appreciated by those skilled in the art that in practice, a relatively soft spring element together with a parallelly paired damping material is also preferably positioned in the gap 38 of FIG. 10 to prevent an impacting action as the reserve linear accelerometer is activated by a sudden high-G acceleration event.

The modified reserve linear accelerometer embodiment 70 of FIGS. 10-12 would then function as follows. When the object to which the reserve linear accelerometer embodiment 70 is attached is accelerated in the direction of the arrow 42, FIG. 10, the acceleration acts on the “high-G support member” 33, the center of mass of which is designed to be below the rotary joint 48 as viewed in the plane of FIG. 10, thereby generating a counterclockwise inertial torque that would tend to rotate the “high-G support member” 33 in the counterclockwise direction.

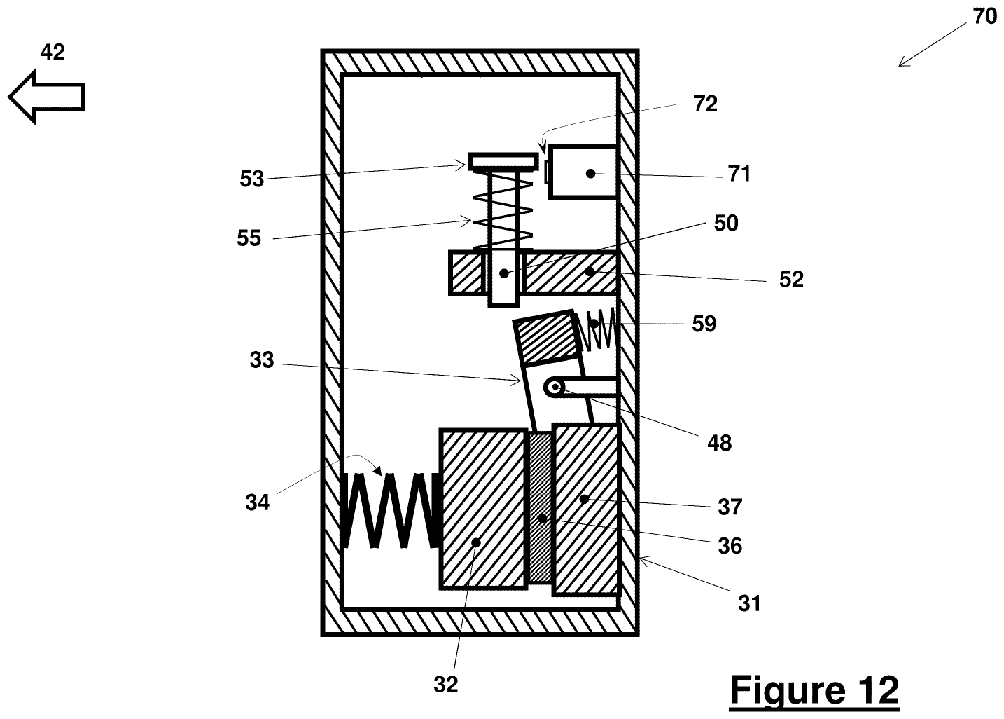

Now if the level of the applied acceleration in the direction of the arrow 42 is at or lower than peak acceleration of the aforementioned prescribed “accelerometer measuring range”, the solenoid 71 is powered by the system using the reserve linear accelerometer 70, retracting the solenoid piston 72, thereby disengaging it from the end piece 53 of the release member 50 as shown in FIG. 12.

As a result, the preloaded compressive spring 55, FIG. 10, would force the release member 50 to slide back away from the “high-G support member” 33 and thereby disengage from it.

As a result, the “high-G support member” 33 is set free to rotate in the counterclockwise direction by the preloaded compressive spring 59 as viewed in the schematic of FIG. 10, and since its center of mass is located below its rotary joint 48, FIG. 10, further counterclockwise inertial torque is also applied to the “high-G support member” to assist its counterclockwise rotation as shown in the schematic of FIG. 12. The preloaded compressive spring 34 would then displace the proof-mass 32 towards the piezoelectric member 36 and close the gap 38, thereby positioning the proof-mass over the surface of the piezoelectric member 36 and applying a compressive load to the piezoelectric member 36, FIG. 12.

It is appreciated that the preloading level of the preloaded compressive spring 34 is usually selected such that the piezoelectric member 36 is under compression in normal (no acceleration) conditions, so that the reserve linear accelerometer embodiment 35 could measure acceleration as well as deceleration in the direction of the arrow 42.

Now if the level of the applied acceleration in the direction of the arrow 42 is beyond the aforementioned prescribed “accelerometer measuring range”, then the solenoid 71 is not powered by the system using the reserve linear accelerometer embodiment 70, therefore the solenoid piston 72 is no retracted and the end piece 53 of the release member 50 stayed engaged with the “high-G support member” 33 as seen in FIG. 10 and the reserve linear accelerometer embodiment 70 is not activated.

It is appreciated by those skilled in the art that the reserve linear accelerometer embodiment 70 would function similarly if subjected to deceleration in the direction of the arrow 42, i.e., it is going to be activated by the system using the reserve accelerometer if the applied deceleration is within the “accelerometer measuring range” by powering the solenoid 71 to actuate, otherwise the reserve accelerometer is not activated.

As a result, if the level of the applied acceleration or deceleration in the direction of the arrow 42 is beyond the aforementioned prescribed “accelerometer measuring range”, then the reserve accelerometer embodiment 70 is not activated, which means that the piezoelectric member (transducer) of the reserve accelerometer is not subjected to high compressive (tensile) force by the applied acceleration (deceleration) in the direction of the arrow 42 acting on the proof-mass 32 of the reserve accelerometer, FIG. 10.

As a result, the proof-mass of the reserve accelerometer may be designed with relatively large mass, thereby allowing the reserve accelerometer to measure acceleration in the direction of the arrow 42 in the prescribed range of low-G acceleration with very high accuracy. In addition, at very high-G accelerations, the piezoelectric member 36 is only subjected to inertial forces resulting from its own inertia to which properly selected piezoelectric member size and type could withstand. The applied high-G acceleration in the direction of the arrow 42 may be in its positive (acceleration) or negative (deceleration) direction.

It is appreciated by those skilled in the art that the above-described method of designing reserve linear accelerometers with tension/compression measuring piezoelectric transducers may also be used to design shear type reserve linear accelerometers.

Such reserve linear accelerometers can then measure acceleration and deceleration in the axial direction of the object to which it is attached. Such shear type accelerometers with their polarization directions being parallel to the longitudinal axis of the accelerometer, e.g., the uprights B2 in FIG. 1B, become less sensitive to temperature transients as compared to other types of accelerometers. In addition, since the piezoelectric members of the reserve accelerometer do not have to be preloaded to measure both acceleration and deceleration, they can be subjected to relatively larger acceleration and deceleration levels since they can withstand larger inertial loads.

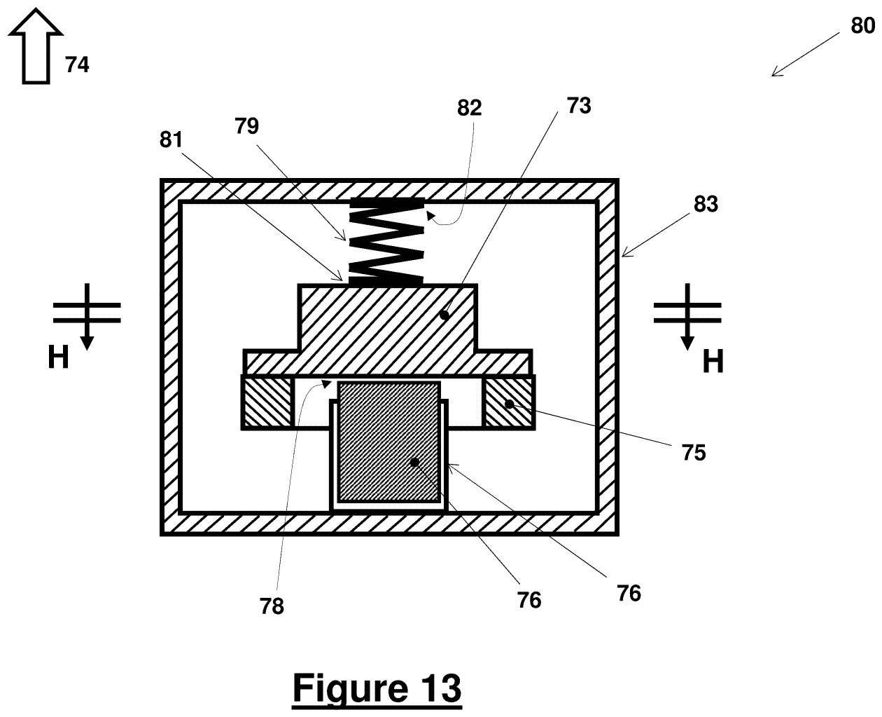

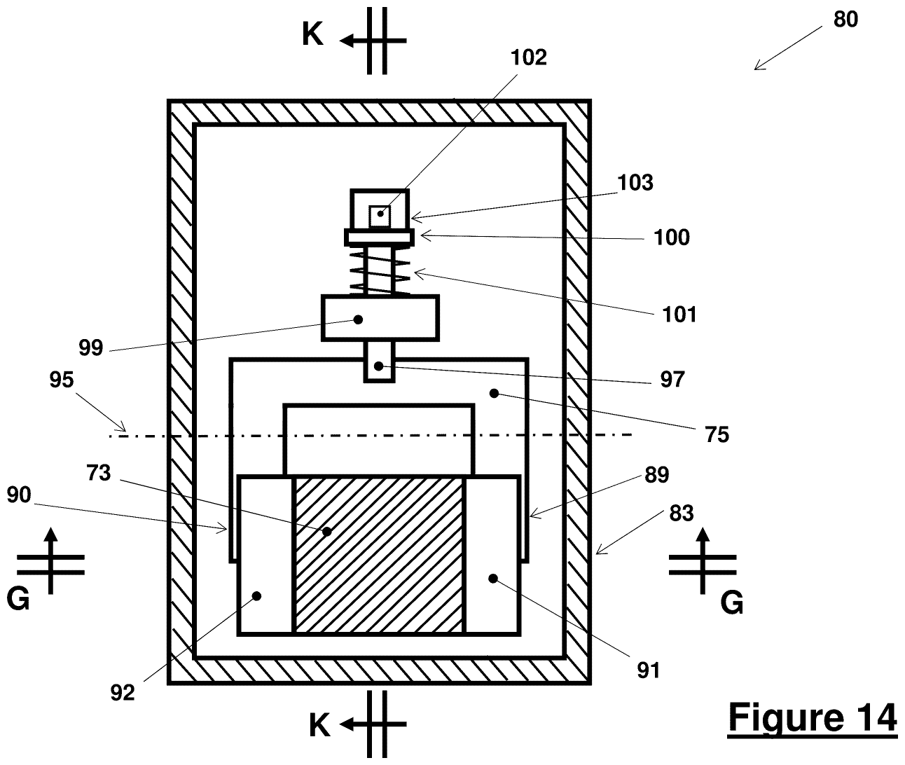

FIG. 13 illustrates the cross-sectional view G-G of FIG. 14 of the fourth embodiment of a high-accuracy piezoelectric-based linear reserve accelerometer of the present invention, which is hereinafter referred to as the “reserve linear accelerometer” embodiment 80 of the present invention. In the schematic of FIG. 13, the reserve linear accelerometer embodiment 80 is shown in its configuration before it is activated to begin accurate measurement of acceleration in the prescribed range of low-G acceleration. This embodiment of the present invention is designed to be activated only if the reserve linear accelerometer is subjected to the prescribed “acceleration measuring range”.

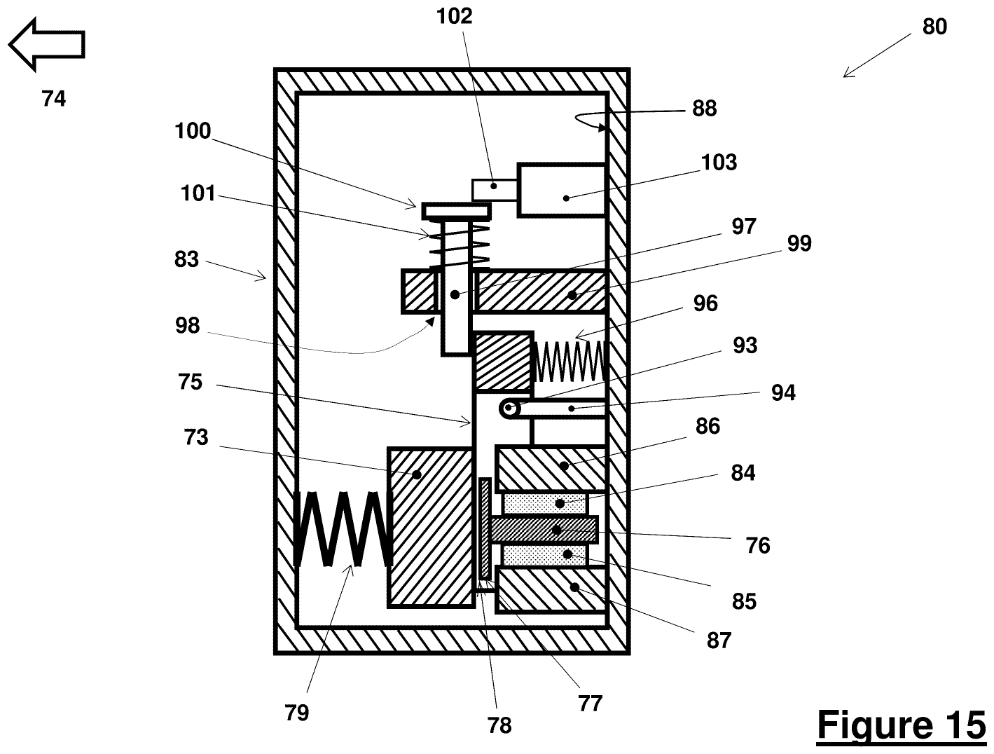

As can be seen in FIG. 13, the reserve linear accelerometer embodiment 80 consists of a “proof-mass” 73, which is being supported by the “high-G support member” 75, FIGS. 13-15. The “high-G support member” 75 is held in this proof-mass support positioning as described later, such that the proof-mass 73 is positioned a very small distance, preferably around 0.001″-0.002″, above the surface of the top section 77, FIG. 15, of the “inertial force transmission member” 76, FIGS. 13 and 15. As a result, a small gap 78 is provided between the proof-mass 73 and the surface of the top section 77 of the “inertial force transmission member” 76, FIGS. 13 and 15. In this configuration of the reserve linear accelerometer embodiment 80, the proof-mass 73 is biased against the surface of the “high-G support member” 75 by the preloaded compressive spring 79. The preloaded compressive spring 79 is fixed to the top surface of the proof-mass 73 on one end 81 and to the inside surface of the reserve linear accelerometer housing 83 on the other end 82.

The pairs of piezoelectric elements (transducers) 84 and 85 are positioned between the support members 86 and 87 and the “inertial force transmission member” 76 as can be seen in FIG. 15. The pairs of piezoelectric elements 84 and 84 are generally attached to the support members 86 and 87 and the “inertial force transmission member” 76 surfaces using commonly used adhesives, usually of epoxy type or the like. The pairs of piezoelectric elements 84 and 85 may be arranged with vertical and/or horizontal polarization directions, whereby the same accelerometer can register motion in several directions perpendicular to one another. The support members 86 and 87 are fixedly attached to the bottom surface 88 of the reserve linear accelerometer housing 83.

FIG. 14 shows the cross-sectional view H-H of FIG. 13. As can be seen in FIG. 14, the “high-G support member” 75 is U-shaped with the sides 89 and 90 providing the means of supporting the sides 91 and 92 of the proof-mass 73, respectively, in the illustrated pre-activation state of the linear accelerometer embodiment 80.

The “high-G support member” 75 is attached to the housing 83 of the reserve linear accelerometer via a rotary joint 48, FIG. 15, with the shaft of the rotary joint passing from the side 89 of the “high-G support member” 75 to the side 90 being shown in the schematic of FIG. 14 by the centerline 43.

FIG. 15 shows the cross-sectional view K-K of FIG. 14. As can be seen in FIG. 15, the “high-G support member” 75 is attached to the base surface 88 of the reserve linear accelerometer housing 83 by a rotary joint 93, via the support member 94. As can be seen in the schematic of FIG. 15, the “high-G support member” 75 is held in its present position by the preloaded compressive spring 96, which is biasing it against release member 97. The release member 97 is free to slide in a guide 98 that is provided in support member 99, which is fixedly attached to the bottom surface 88 of the reserve accelerometer housing 83. The release member 97 is provided with an end piece 100, between which and the support member 99 is positioned a preloaded compressive spring 101. The preloaded compressive spring 101 is used to bias the end piece 100 against the piston 102 of the solenoid 103. The solenoid 103 is fixedly attached to the bottom surface 88 of the reserve accelerometer housing 83.

It is appreciated by those skilled in the art that in practice, a relatively soft spring element together with a parallelly paired damping material is preferably positioned in the gap 78, FIG. 15, and also in all such disclosed embodiments of the present invention, to prevent an impacting action as the reserve linear accelerometer is activated.

The reserve linear accelerometer embodiment 89 of FIGS. 13-15 would then function as follows. When the object to which the reserve linear accelerometer embodiment 80 is attached is accelerated in the direction of the arrow 74, FIGS. 13 and 15, the acceleration acts on the “high-G support member” 75, the center of mass of which is designed to be below the rotary joint 93 as viewed in the plane of FIG. 15, thereby generating a counterclockwise inertial torque that would tend to rotate the “high-G support member” 75 in the counterclockwise direction.

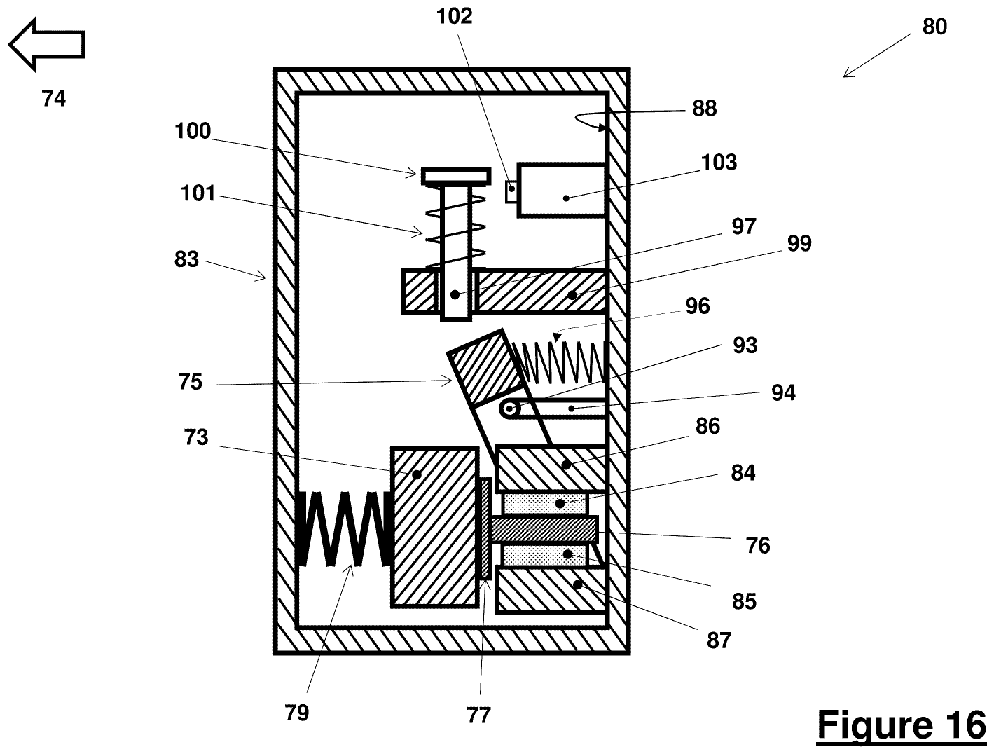

Now if the level of the applied acceleration in the direction of the arrow 74 is at or lower than peak acceleration of the aforementioned prescribed “accelerometer measuring range”, the solenoid 103 is powered by the system using the reserve linear accelerometer 80, retracting the solenoid piston 102, thereby disengaging it from the end piece 100 of the release member 97 as shown in FIG. 16.

As a result, the preloaded compressive spring 101, FIG. 15, would force the release member 97 to slide back away from the “high-G support member” 75 and thereby disengage from it.

As a result, the “high-G support member” 75 is set free to rotate in the counterclockwise direction by the preloaded compressive spring 96 as viewed in the schematic of FIG. 15, and since its center of mass is located below its rotary joint 93, FIG. 15, further counterclockwise inertial torque is also applied to the “high-G support member” to assist its counterclockwise rotation as shown in the schematic of FIG. 16. The preloaded compressive spring 79 would then displace the proof-mass 73 towards the surface of the top section 77, FIG. 15, of the “inertial force transmission member” 76, thereby positioning the proof-mass over the surface of the top section 77 and applying a relatively small compressive load to the “inertial force transmission member” 76.

It is appreciated that the preloading level of the preloaded compressive spring 79 is usually selected to just enough to keep the proof-mass from separating from the “inertial force transmission member” 76 during the entire range of acceleration that it is subjected to and must make its measurement. In general, a guide is also provided (not shown) for the proof-mass 73 so that it is not accidentally displaced in its lateral direction, i.e., in a direction normal to the direction of the arrow 74.

Now if the level of the applied acceleration in the direction of the arrow 74 is beyond the aforementioned prescribed “accelerometer measuring range”, then the solenoid 103 is not powered by the system using the reserve linear accelerometer embodiment 80, therefore the solenoid piston 102 is not retracted and the end piece 100 of the release member 97 stays engaged with the “high-G support member” 75 as seen in FIG. 15 and the reserve linear accelerometer embodiment 80 is not activated.

It is appreciated by those skilled in the art that the reserve linear accelerometer embodiment 80 would function similarly if subjected to deceleration in the direction of the arrow 74, i.e., it is going to be activated by the system using the reserve accelerometer if the applied deceleration is within the “accelerometer measuring range” by powering the solenoid 103 to actuate, otherwise the reserve accelerometer is not activated.

As a result, if the level of the applied acceleration or deceleration in the direction of the arrow 74 is beyond the aforementioned prescribed “accelerometer measuring range”, then the reserve accelerometer embodiment 80 is not activated, which means that the piezoelectric members (transducers) of the reserve accelerometer are not subjected to high shearing stresses by the applied acceleration (deceleration) in the direction of the arrow 74 acting on the proof-mass 73 of the reserve accelerometer, FIG. 15.

As a result, the proof-mass of the reserve accelerometer may be designed with relatively large mass 73, thereby allowing the reserve accelerometer to measure acceleration in the direction of the arrow 74 in the prescribed range of low-G acceleration with very high accuracy. In addition, at high-G accelerations at which time the reserve accelerometer is not activated, when the piezoelectric members 84 and 85 are only subjected to inertial forces generated by the mass of the “inertial force transmission member” 76, FIG. 15, which is designed to be low.

It is appreciated by those skilled in the art that in applications such as those in gun-fired munitions, the munition and thereby all its components, including its reserve accelerometer, would be subjected to high-G setback acceleration as well as smaller but considerable set-forward acceleration (i.e., acceleration in the opposite direction of the setback acceleration), which could also be well above the low-G “accelerometer measuring range”, during which reserve accelerometer activation must also be prevented. In such applications, the reserve accelerometers which are used for guidance and control purposes are activated following the set-forward acceleration event when they would start making accurate measurement of acceleration for system guidance and control purposes.

It is appreciated that in the above reserve accelerometer embodiments 10, 35, 70 and 80 of FIGS. 1-4, 5-9, 10-12 and 13-16, respectively, the proof-mass is not fixedly attached to the accelerometer transducer (the piezoelectric elements directly or via an intermediate member in the case of the shear type piezoelectric transducers), but is laid over the transducer as the reserve accelerometer is activated and held firmly against the transducer (or its intermediate member) by a preloaded spring member. In certain applications, particularly when the reserve accelerometer, before or during or after activation, is subjected to severe lateral or rotary acceleration, the proof-mass of the reserve accelerometer must be provided with lateral and rotational constraints to ensure that they do not slide and/or rotate relative to the accelerometer transducer.

Alternatively, the reserve linear accelerometers may be designed with proof-masses that are fixedly attached to the accelerometer transducer, i.e., the piezoelectric elements, directly or via an intermediate member in the case of the shear type piezoelectric transducers. The method of designing such reserve linear accelerometers is described below by its application to a shear type reserve linear accelerometer design, which is indicated as the fifth reserve linear accelerometer embodiment 110 of the present invention. It is appreciated by those skilled in the art that the method may be readily applied to the previously disclosed embodiments of the present invention.

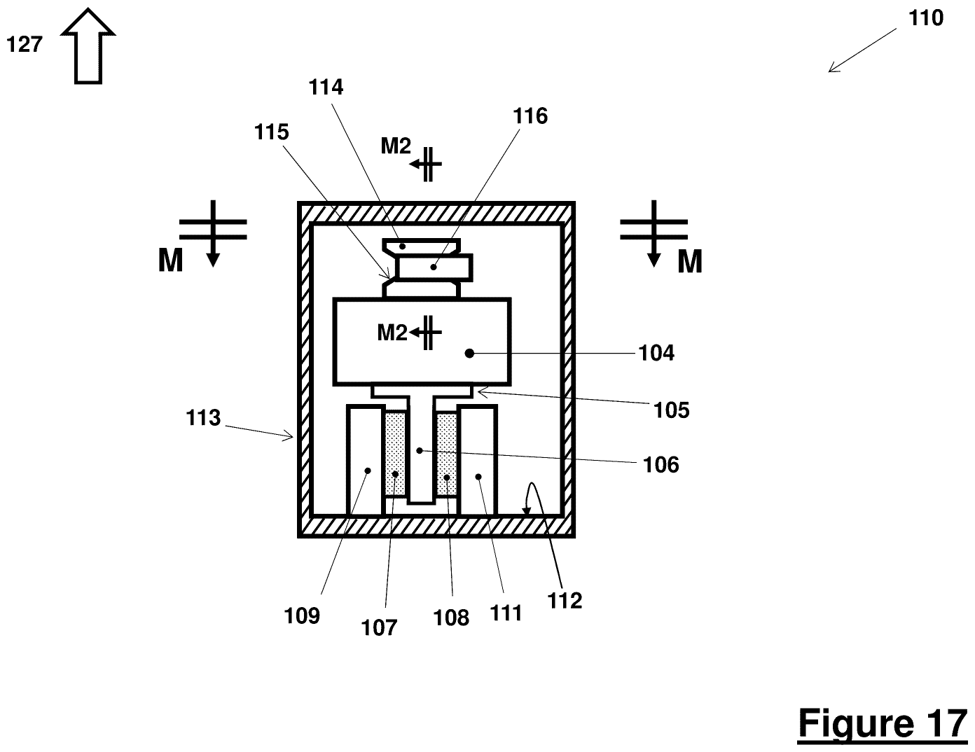

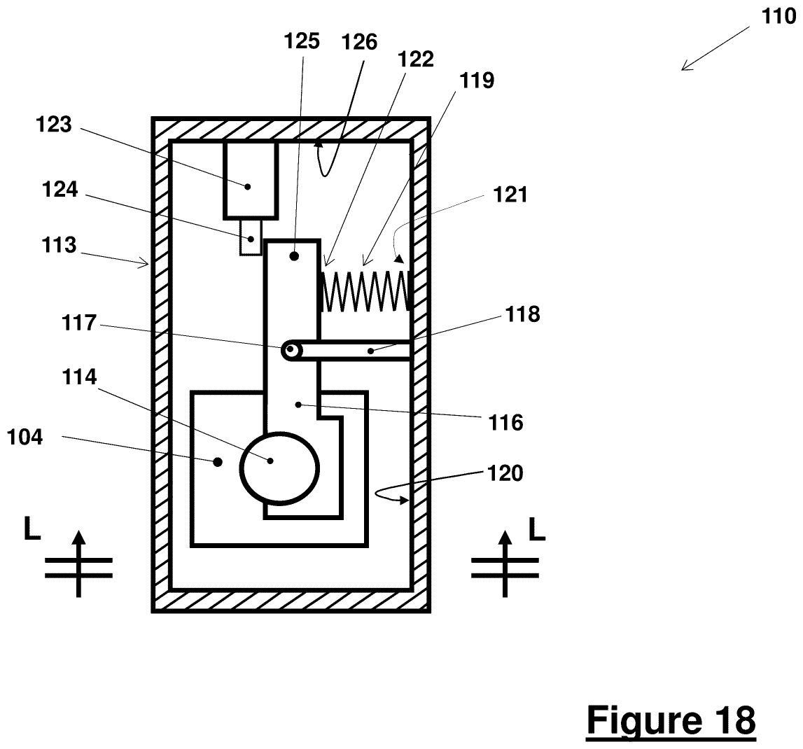

FIG. 17 illustrates the cross-sectional view L-L of FIG. 18 of the fifth embodiment of a high-accuracy piezoelectric-based shear-type linear reserve accelerometer of the present invention, which is hereinafter referred to as the “reserve linear accelerometer” embodiment 110 of the present invention. In the schematic of FIG. 17, the reserve linear accelerometer embodiment 110 is shown in its configuration before it is activated to begin accurate measurement of acceleration in the prescribed range of low-G acceleration. This embodiment of the present invention is designed to be activated only if the reserve linear accelerometer is subjected to the prescribed “acceleration measuring range”.

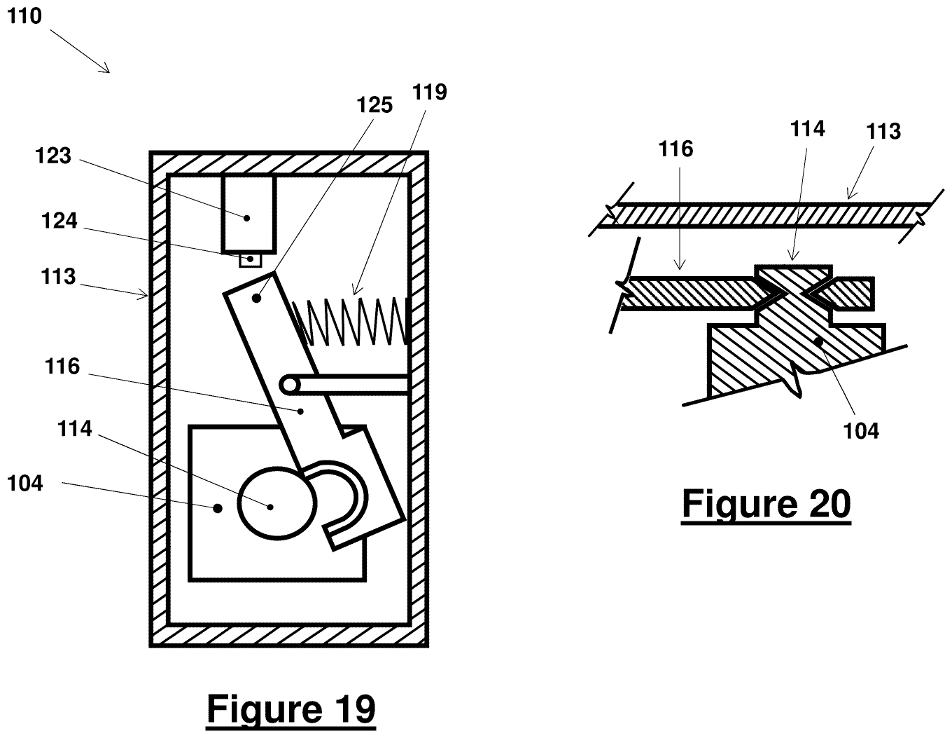

It is noted that in the cross-sectional view of FIG. 17, the support member 118 and the preloaded compressive spring 119, FIG. 19, are not shown for the sake of clarity.

As can be seen in FIG. 17, the reserve linear accelerometer embodiment 110 consists of a “proof-mass” 104, which is fixedly attached to the surface of the top section 105 of the “inertial force transmission member” 106. Pairs of piezoelectric elements (transducers) 107 and 108 are positioned between the support members 109 and 111, respectively, and the “inertial force transmission member” 106 as can be seen in FIG. 17. The pairs of piezoelectric elements 107 and 108 are generally attached to the support members 109 and 111 and the “inertial force transmission member” 106 surfaces using commonly used adhesives, usually of epoxy type or the like. The pairs of piezoelectric elements 107 and 108 may be arranged with vertical and/or horizontal polarization directions, whereby the same accelerometer can register motion in several directions perpendicular to one another. The support members 109 and 111 are fixedly attached to the bottom surface 112 of the reserve linear accelerometer housing 113.

The proof-mass 104 is also provided with a top member 114, which has a nearly “V” shaped groove that is used to engage with a mating “U” shaped section of the release link 116, FIGS. 17 and 18, as shown in the partial cross-sectional view of FIG. 20.

FIG. 18 shows the cross-sectional view M-M of FIG. 17. The release link 116 is seen in full engagement with the “V” grooved top member 114 of the proof-mass 104 as shown in the partial cross-sectional view M2-M2 of FIG. 17 presented in the schematic of FIG. 20. The release link 116 is seen to be attached to the side surface 120 of the reserve linear accelerometer housing 113 by a rotary joint 117 via the support member 118. An electrically actuated solenoid 123 with its piston 124 is also provided and is fixedly attached to the side 126 of the reserve linear accelerometer housing 113 as can be seen in FIG. 17. In the illustrated pre-activation configuration of the reserve linear accelerometer embodiment 110 of FIG. 18, the end section 125 of the release link 116 is shown to rest against the extended piston 124 of the solenoid 123 and is biased in this position by the provided preloaded compressive spring 119, which applies a force that applies a counterclockwise torque to the release link 116. The preloaded compressive spring 119 is fixedly attached to the surface 120 of the reserve linear accelerometer housing 113 on one end 121 and to the end section 125 of the release link 116 on the other end 122.

The reserve linear accelerometer embodiment 110 of FIGS. 17-20 would then function as follows. Consider the configuration of the reserve linear accelerometer shown in FIGS. 17 and 18. When the object to which the reserve linear accelerometer embodiment 110 is attached is accelerated in the direction of the arrow 127, FIG. 17, the acceleration acts on the mass of the proof-mass 104 and as a result applies a downward inertial force to the proof-mass 104 as viewed in FIG. 17. It is appreciated that if the acceleration was in the opposite direction of the arrow 127, the generated inertial force would act in the upward direction on the proof-mass 104. It is noted that the mass of the “inertial force transmission member” 106 is to be added to the mass of the proof-mass 104.

Now, if the release link 116 is designed to be effectively rigid as compared to the flexibility of the piezoelectric members (transducers) in shear in the direction parallel to the direction of the arrow 127, then the generated downward or upward inertial forces would be supported by the release link 116. As a result, the reserve linear accelerometer embodiment 110 would effectively not respond to the applied acceleration in the direction of the arrow 127 or in its opposite direction, even if the applied acceleration is relatively high-G, i.e., significantly higher in its level as compared to the maximum level of the low-G prescribed acceleration measuring range for the reserve linear accelerometer.

Now if the level of the applied acceleration in the direction of the arrow 127 is at or lower than peak acceleration of the aforementioned prescribed “accelerometer measuring range”, the solenoid 123 is powered by the system using the reserve linear accelerometer 110, retracting the solenoid piston 124, thereby disengaging it from the end section 125 of the release link 116 as shown in FIG. 19.

As a result, the preloaded compressive spring 119, FIG. 19, would force the release link 116 to rotate in the counterclockwise direction, thereby disengaging the “V” grooved top member 114 of the proof-mass 104. As a result, the proof-mass 104 is set free to respond to acceleration or deceleration in the direction of the arrow 127 and apply shearing force proportional to the applied acceleration or deceleration to the pair of piezoelectric members 107 and 108 via the “inertial force transmission member” 106. The reserve linear accelerometer embodiment 110 would then perform its function of accurately measuring acceleration and deceleration in the direction of the arrow 127.

Now if the level of the applied acceleration in the direction of the arrow 127 is beyond the aforementioned prescribed “accelerometer measuring range”, then the solenoid 123 is not powered by the system using the reserve linear accelerometer embodiment 110, therefore the solenoid piston 124 is not retracted and the end section 125 of the release link 116 and stays engaged with the “V” grooved top member 114 of the proof-mass 104 as shown in FIGS. 18 and 20, and the reserve linear accelerometer embodiment 110 is not activated.

It is appreciated by those skilled in the art that the reserve linear accelerometer embodiment 110 would function similarly if subjected to deceleration in the direction of the arrow 127, i.e., it is going to be activated by the system using the reserve accelerometer if the applied deceleration is within the “accelerometer measuring range” by powering the solenoid 123 to actuate, otherwise the reserve accelerometer is not activated.

As a result, if the level of the applied acceleration or deceleration in the direction of the arrow 127 is beyond the aforementioned prescribed “accelerometer measuring range”, then the reserve accelerometer embodiment 110 is not activated, which means that the piezoelectric members (transducers) of the reserve accelerometer are not subjected to high shearing stresses by the applied acceleration (deceleration) in the direction of the arrow 127 acting on the proof-mass 104 of the reserve accelerometer, FIG. 17.

As a result, the proof-mass 104 of the reserve linear accelerometer embodiment 110 of FIGS. 17-20 may be designed with relatively large mass, thereby allowing the reserve accelerometer to measure acceleration in the direction of the arrow 127 in the prescribed range of low-G acceleration with very high accuracy.

In an alternative construction of the reserve linear accelerometer embodiment 110 of FIGS. 17-20, the release link 116 is designed to have a certain amount of bending flexibility to allow certain amount of deflection of the release link 116 at its point of engagement with the “V” grooved top member 114 of the proof-mass 104 due to the generated inertial force by the proof-mass as the reserve accelerometer is accelerated or decelerated in the direction of the arrow 127, FIGS. 17 and 18. The release link 116 is however still constructed to be highly rigid in bending about its axis of rotary joint 117.

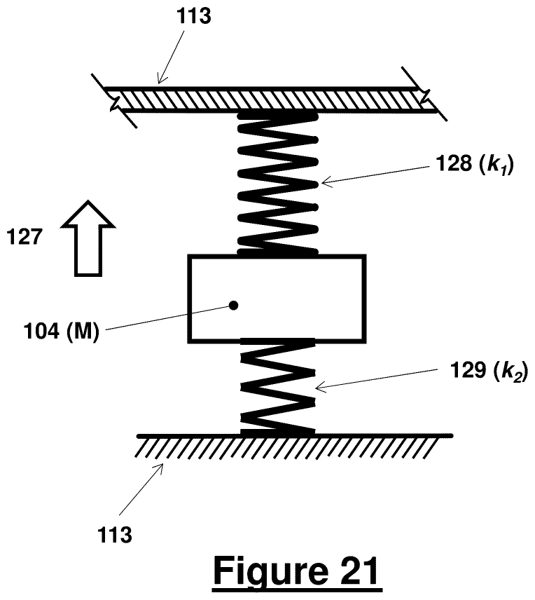

As a result, the release link 116 would effectively act as a spring element that is used to connect the proof-mass 104 to the structure of the housing 113 of the reserve linear accelerometer embodiment 110 as depicted in the model of FIG. 21. It is appreciated by those skilled in the art, that all fabricated accelerometers such as all disclosed reserve accelerometers are generally calibrated before being used. In which case, all other structural flexibility, such as those associated with the accelerometer housing and other relevant components of the accelerometer are usually accounted for. In the structural model of FIG. 21, spring 128 is intended to represent the bending flexibility of the release link 116 and the indicated possible relevant structural flexibilities of the reserve accelerometer embodiment 110.

In the structural model of FIG. 21, the spring 128 represents the equivalent bending flexibility of the release link 116 at the center of its engagement with the “V” grooved top member 114 of the proof-mass 104, and includes the flexibilities of other connecting elements between the reserve linear accelerometer housing 113 connection to the release link, the proof mass, etc., all in the direction of displacing the “inertial force transmission member” 106 downward as viewed in the schematic of FIG. 17, which would tend to result in a shearing strain in the piezoelectric members 107 and 108 in that direction. The spring 129 is intended to represent the shearing flexibility of the piezoelectric members 107 and 108, which indicates the response of the reserve linear accelerometer embodiment 110 of FIGS. 17-20 to the applied acceleration or deceleration in the direction of the arrow 127.

It is appreciated by those skilled in the art that as can be seen from the structural model of FIG. 21, when the reserve linear accelerometer embodiment 110 of FIGS. 17-20 is accelerated or decelerated in the direction of the arrow 127, the acceleration (deceleration) acts on the effective mass of the proof-mass 104 and generate a proportional inertial force in the direction of the applied acceleration (deceleration). Now, if the effective mass of the proof-mass 104 is indicated as M, and the spring rates of the springs 128 and 129 are indicated as k₁ and k₂, respectively, then by the application of an acceleration level a in the direction of the arrow 127, the proof-mass 104 is displaced a distance d (in the direction of the applied acceleration) given by the following relationship:

$$d = Ma / ( {k}_{1} + {k}_{2} ) \qquad ( 1 )$$

It is appreciated that the distance d in equation (1) corresponds to the shear displacement applied to the piezoelectric members 107 and 108, and that the effect of the spring rate k₁ is to reduce the shear displacement of the piezoelectric members 107 and 108 from the application of the acceleration in the direction of the arrow 127.

It is therefore appreciated by those skilled in the art that by providing a certain level of bending flexibility for the release link 116, the amount of shearing displacement d that is applied to the piezoelectric members 107 and 108 is controlled. This capability can then be used to provide the reserve linear accelerometer embodiment 110 of FIGS. 17-20 with the capability to measure the level of applied high-G accelerations or decelerations prior to the activation of the reserve linear accelerometer and to still very accurately measure the low-G accelerations and decelerations within the prescribed acceleration measuring range once the reserve accelerometer is activated as described below.

Consider the condition shown in FIG. 18 in which the reserve linear accelerometer embodiment 110 is not activated and the release link is in engagement with the “V” grooved top member 114 of the proof-mass 104. The structural model of FIG. 21 describes the proof-mass 104 displacement as a result of acceleration or deceleration in the direction of the arrow 127 as given by equation (1). Now assume that the reserve accelerometer is expected to be subjected to high-G accelerations or decelerations in the direction of the arrow 127, and once it is activated, it is expected to very accurately measure acceleration or deceleration in the same direction. For example, if the high-G acceleration level is +1000 G while the peak acceleration in the prescribed acceleration measuring range is 10 G, then by choosing a spring rate of k₂=99 k₁, then the maximum shearing displacement d that is applied to the piezoelectric members 107 and 108 becomes 1/100 before reserve accelerometer activation, which would be within the range of their design for accurate measurement of acceleration within the prescribed acceleration measuring range of 10 G. The reserve linear accelerometer can therefore measure the applied high-G acceleration and deceleration in the direction of the arrow 127 before its activation (obviously with less sensitivity than the prescribed low-G acceleration and deceleration measurement), but once activated, it would accurately measure acceleration within the prescribed acceleration measuring range.

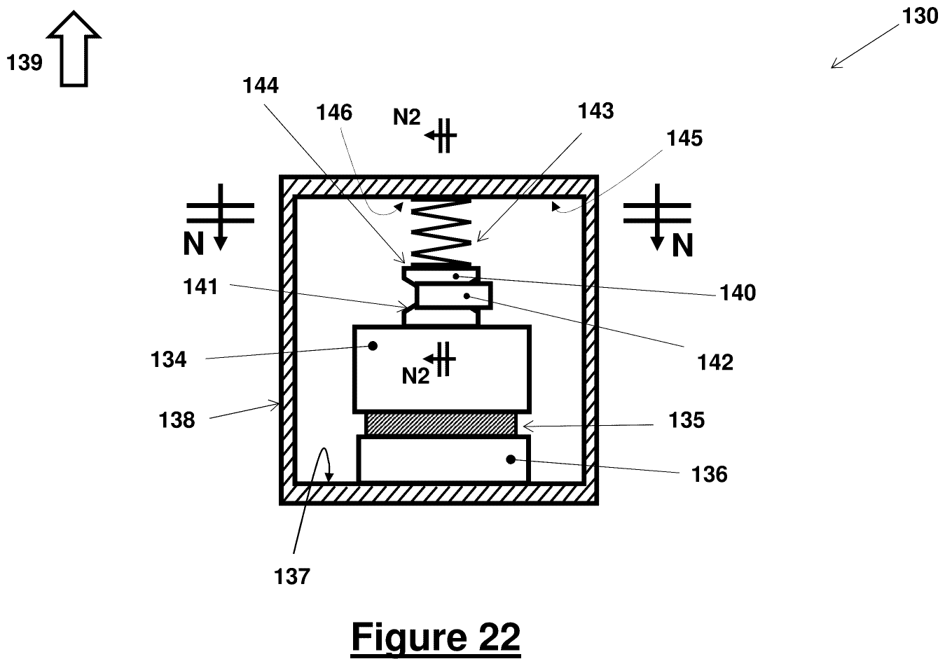

It is appreciated that in the method used to design the reserve linear accelerometer embodiment 110 of FIGS. 17-20, the proof-mass is fixedly attached to the accelerometer transducer (piezoelectric member directly or via some intermediate element). A mechanism is then provided that can lock the proof-mass to the structure of the accelerometer while the accelerometer is in its pre-activation, i.e., reserve, state. As a result, when the reserve accelerometer is subjected to a high-G acceleration, a negligible amount of inertial force is transmitted to the accelerometer transducer. However, once the reserve accelerometer is activated, i.e., once the locking mechanism releases the proof-mass and it is therefore free to displace relative to the structure of the accelerometer, then the relatively large mass of the proof-mass allows the applied acceleration to be very accurately measured by the accelerometer transducer as was described for the reserve linear accelerometer embodiment 110 of FIGS. 17-20, which is provided with a shear type piezoelectric members as transducers. This method may also be readily applied to reserve accelerometers that are equipped with compressive/tensile type piezoelectric transducers, such as the reserve linear accelerometer of embodiment 130 of FIGS. 22-25.

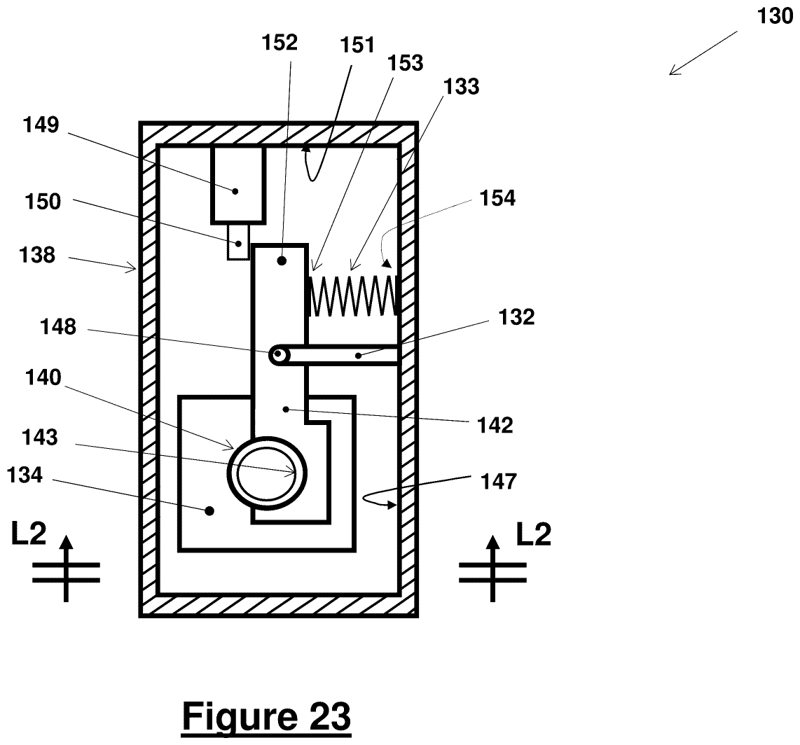

FIG. 22 illustrates the cross-sectional view L2-L2 of FIG. 23 of the sixth embodiment of a high-accuracy piezoelectric-based tension/compression type linear reserve accelerometer of the present invention, which is hereinafter referred to as the “reserve linear accelerometer” embodiment 130 of the present invention. In the schematic of FIG. 22, the reserve linear accelerometer embodiment 130 is shown in its configuration before it is activated to begin accurate measurement of acceleration in the prescribed range of low-G measuring acceleration. This embodiment of the present invention is designed to be activated only if the reserve linear accelerometer is subjected to the prescribed “acceleration measuring range” in the direction of the arrow 139.

It is noted that in the cross-sectional view of FIG. 22, the support member 132 and the preloaded compressive spring 132, FIG. 23, are not shown for the sake of clarity.

As can be seen in FIG. 22, the reserve linear accelerometer embodiment 130 consists of “proof-mass” 134, which is fixedly attached to the top surface of the piezoelectric member (transducer) 135, which is in turn fixedly attached to a support member 136. The support member 136 is then fixedly attached to the inside surface 137 of the reserve accelerometer housing 138. The piezoelectric member 135 is usually attached to the support member 136 and the proof-mass 134 using commonly used adhesives, usually of epoxy type or the like. The piezoelectric member 135 is polarized to measure compressive and tensile forces parallel to the direction of the arrow 139, which is the direction of the prescribed acceleration that the reserve accelerometer is designed to measure.

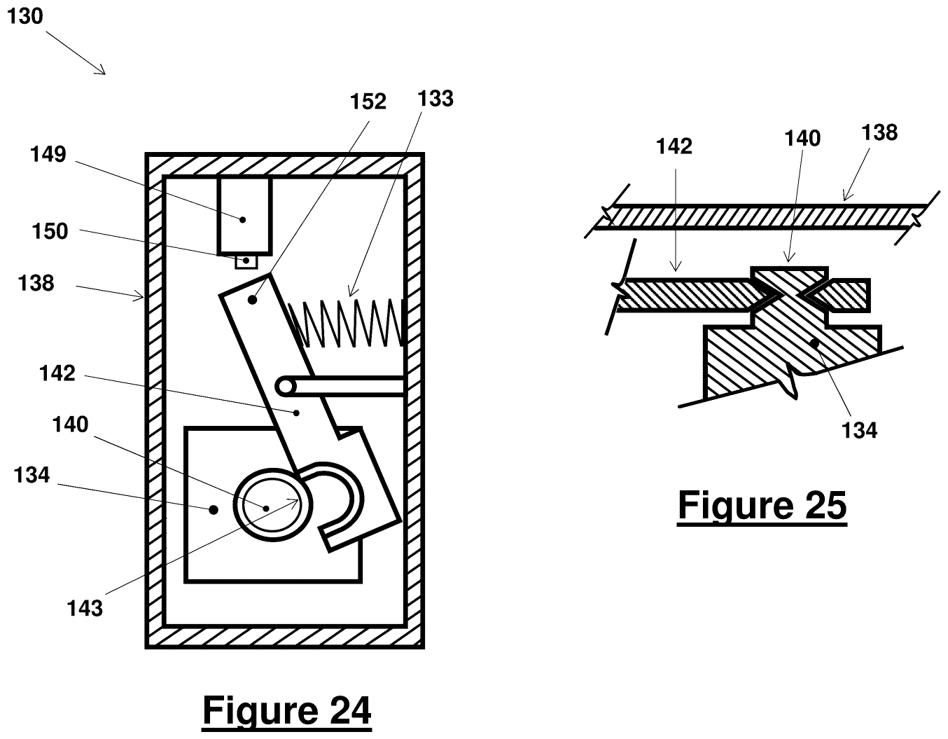

The proof-mass 134 is also provided with a top member 140, which has a nearly “V” shaped groove that is used to engage with a mating “U” shaped section of the release link 142, FIGS. 23 and 24, as shown in the partial cross-sectional view of FIG. 25. A preloaded compressive spring 143 is also provided that is attached to the top member 140 of the proof-mass 134 on one end 144 and to the top interior surface 145 of the reserve accelerometer housing 145 on the other end 146.

FIG. 23 shows the cross-sectional view N-N of FIG. 22. The release link 142 is seen in full engagement with the “V” grooved top member 140 of the proof-mass 134 as shown in the partial cross-sectional view N2-N2 of FIG. 22 presented in the schematic of FIG. 25. The release link 142 is seen to be attached to the side surface 147 of the reserve linear accelerometer housing 138 by a rotary joint 148 via the support member 132. An electrically actuated solenoid 149 with its piston 150 is also provided and is fixedly attached to the side 151 of the reserve linear accelerometer housing 138 as can be seen in FIG. 23.

In the illustrated pre-activation configuration of the reserve linear accelerometer embodiment 110 of FIG. 23, the end section 152 of the release link 142 is shown to rest against the extended piston 150 of the solenoid 149 and is biased in this position by the provided preloaded compressive spring 133, which applies a force that applies a counterclockwise torque to the release link 134. The preloaded compressive spring 133 is fixedly attached to the surface 147 of the reserve linear accelerometer housing 138 on one end 154 and to the end section 152 of the release link 142 on the other end 153.

The reserve linear accelerometer embodiment 130 of FIGS. 22-25 would then function as follows. Consider the configuration of the reserve linear accelerometer shown in FIGS. 22 and 23. When the object to which the reserve linear accelerometer embodiment 130 is attached is accelerated in the direction of the arrow 139, FIG. 22, the acceleration acts on the mass of the proof-mass 134 and as a result applies a downward inertial force to the proof-mass 134 as viewed in FIG. 22. It is appreciated that if the acceleration was in the opposite direction of the arrow 127, the generated inertial force would act in the upward direction on the proof-mass 134.

Now, if the release link 142 is designed to be effectively rigid as compared to the flexibility of the piezoelectric member (transducers) 135 and its support member 136 in the direction parallel to the direction of the arrow 139, then the generated downward or upward inertial forces acting on the proof-mass 134 would be supported by the release link 142, FIGS. 22 and 23. As a result, the reserve linear accelerometer embodiment 130 would effectively not respond to the applied acceleration in the direction of the arrow 139 or in its opposite direction, even if the applied acceleration is relatively high-G, i.e., significantly higher in its level as compared to the maximum level of the low-G prescribed acceleration measuring range for the reserve linear accelerometer.

Now if the level of the applied acceleration in the direction of the arrow 139 is at or lower than peak acceleration of the aforementioned prescribed “accelerometer measuring range”, the solenoid 149 is powered by the system using the reserve linear accelerometer 130, retracting the solenoid piston 150, thereby disengaging it from the end section 152 of the release link 142 as shown in FIG. 24.

As a result, the preloaded compressive spring 133, FIG. 23, would force the release link 141 to rotate in the counterclockwise direction, thereby disengaging the “V” grooved top member 140 of the proof-mass 134. As a result, the proof-mass 134 is set free to respond to acceleration or deceleration in the direction of the arrow 139 and apply an inertial force proportional to the applied acceleration or deceleration to the piezoelectric member 135. The reserve linear accelerometer embodiment 130 would then perform its function of accurately measuring acceleration and deceleration in the direction of the arrow 139.

It is appreciated that the preloading level of the preloaded compressive spring 143 is usually selected such that the piezoelectric member 135 is under compression in normal (no acceleration) conditions, so that the reserve linear accelerometer embodiment 130 can measure acceleration as well as deceleration in the direction of the arrow 139.

Now if the level of the applied acceleration in the direction of the arrow 139 is beyond the aforementioned prescribed “accelerometer measuring range”, then the solenoid 149 is not powered by the system using the reserve linear accelerometer embodiment 130, therefore the solenoid piston 150 is not retracted and the end section 152 of the release link 142 and stays engaged with the “V” grooved top member 140 of the proof-mass 134 as shown in FIGS. 23 and 25, and the reserve linear accelerometer embodiment 130 is not activated.

It is appreciated by those skilled in the art that the reserve linear accelerometer embodiment 130 would function similarly if subjected to deceleration in the direction of the arrow 139, i.e., it is going to be activated by the system using the reserve accelerometer if the applied deceleration is within the “accelerometer measuring range” by powering the solenoid 149 to actuate, otherwise the reserve accelerometer is not activated.

As a result, if the level of the applied acceleration or deceleration in the direction of the arrow 139 is beyond the aforementioned prescribed “accelerometer measuring range”, then the reserve accelerometer embodiment 130 is not activated, which means that the piezoelectric member (transducer) of the reserve accelerometer is not subjected to high compressive (tensile) stress by the applied acceleration (deceleration) in the direction of the arrow 139 acting on the proof-mass 134 of the reserve accelerometer, FIG. 22.

As a result, the proof-mass 134 of the reserve linear accelerometer embodiment 130 of FIGS. 22-25 may be designed with relatively large mass, thereby allowing the reserve accelerometer to measure acceleration in the direction of the arrow 139 in the prescribed range of low-G acceleration with very high accuracy.

In an alternative construction of the reserve linear accelerometer embodiment 130 of FIGS. 22-25, the release link 142 is designed to have a certain amount of bending flexibility to allow for deflection of the release link 142 at its point of engagement with the “V” grooved top member 140 of the proof-mass 134 due to the generated inertial force by the proof-mass 134 as the reserve accelerometer is accelerated or decelerated in the direction of the arrow 139, FIGS. 22 and 23. The release link 142 is however still constructed to be highly rigid in bending about its rotary joint 148 axis.

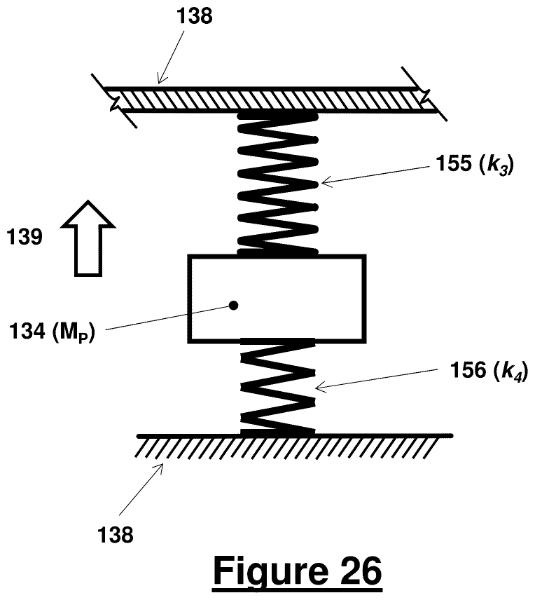

As a result, the release link 142 would effectively act as a spring element that is used to connect the proof-mass 134 to the structure of the housing 138 of the reserve linear accelerometer embodiment 130 as depicted in the model of FIG. 26.

It is appreciated by those skilled in the art, that all fabricated accelerometers such as all disclosed reserve accelerometers are generally calibrated before being used. In which case, all other structural flexibility, such as those associated with the accelerometer housing and other relevant components of the accelerometer are usually accounted for. In the structural model of FIG. 26, spring 155 is intended to represent the contributing bending flexibility of the release link 142 and the indicated possible relevant structural flexibilities of the reserve accelerometer embodiment 130.

In the structural model of FIG. 26, the spring 155 represents the equivalent bending flexibility of the release link 142 at the center of its engagement with the “V” grooved top member 140 of the proof-mass 134, and includes the flexibilities of other connecting elements between the reserve linear accelerometer housing 138 connection to the release link, the proof mass, etc., all in the direction of the arrow 139 as viewed in the schematic of FIG. 22, which would tend to result in a compressive or tensile strain of the piezoelectric member 135 in that direction. The spring 156 is intended to represent the flexibility of the piezoelectric member 135, which indicates the response (strain) of the reserve linear accelerometer embodiment 130 of FIGS. 22-25 to the applied acceleration or deceleration in the direction of the arrow 139.

It is appreciated by those skilled in the art that as can be seen from the structural model of FIG. 26, when the reserve linear accelerometer embodiment 130 of FIGS. 22-25 is accelerated or decelerated in the direction of the arrow 139, the acceleration (deceleration) acts on the effective mass of the proof-mass 134 and generate a proportional inertial force in the direction of the applied acceleration (deceleration). Now, if the effective mass of the proof-mass 134 is indicated as M_{P}, and the spring rates of the springs 155 and 156 are indicated as k₃ and k₄, respectively, then by the application of an acceleration level a in the direction of the arrow 139, the proof-mass 134 is displaced a distance d_{P} (in the direction of the applied acceleration) given by the following relationship:

$${d}_{P} = {M}_{P} a / ( {k}_{3} + {k}_{4} ) \qquad ( 2 )$$

It is appreciated that the distance d_{P} in equation (2) corresponds to the applied longitudinal strain to the piezoelectric member 135, and that the effect of the spring rate k₃ is to reduce the longitudinal strain of the piezoelectric member 135 from the application of the acceleration in the direction of the arrow 139.

It is therefore appreciated by those skilled in the art that by providing a certain level of bending flexibility for the release link 142, the amount of longitudinal strain d_{P} that is applied to the piezoelectric member 135 is controlled. This capability can then be used to provide the reserve linear accelerometer embodiment 130 of FIGS. 22-25 with the capability to measure the level of applied high-G accelerations or decelerations prior to the activation of the reserve linear accelerometer and to still very accurately measure the low-G accelerations and decelerations within the prescribed acceleration measuring range once the reserve accelerometer is activated as described below.

Consider the condition shown in FIG. 23 in which the reserve linear accelerometer embodiment 130 is not activated and the release link is in engagement with the “V” grooved top member 140 of the proof-mass 134. The structural model of FIG. 26 describes the proof-mass 134 displacement as a result of acceleration or deceleration in the direction of the arrow 139 as given by equation (2). Now assume that the reserve linear accelerometer is expected to be subjected to high-G accelerations or decelerations in the direction of the arrow 139 and once it is activated, it is expected to very accurately measure acceleration or deceleration in the same direction. For example, if the high-G acceleration level is ±1000 G while the peak acceleration in the prescribed acceleration measuring range is 10 G, then by choosing a spring rate of k₃=99 k₄, the displacement (strain) d_{P} that is applied to the piezoelectric member 135, FIG. 22, is reduced by a factor of 1/100 while the reserve accelerometer is not activated. As a result, even at peak acceleration of 1,000 G, the piezoelectric member 135 is subjected to only 10 G, which is not above its designed limit for low-G acceleration measurement.

The reserve linear accelerometer can therefore measure the applied high-G acceleration and deceleration in the direction of the arrow 139 before its activation (obviously with less sensitivity than the prescribed low-G acceleration and deceleration measurement), but once activated, it would accurately measure acceleration within the prescribed acceleration measuring range.

It is appreciated that in the method used to design the reserve linear accelerometer embodiments 110 and 130 of FIGS. 15-20 and 22-25, respectively, once the reserve linear accelerometer is activated, they cannot be returned to their pre-activation state. In certain applications, however, the system in which the reserve accelerometer is mounted may be required to undertake certain operation for which the reserve accelerometer must be activated and at the completion of the operation, the reserve accelerometer input is no longer needed. The system may also be initially subjected to a high-G acceleration event, during which the reserve accelerometer transducer must be protected as it was previously described. This is usually the case for many UAV applications in which the UAV is subjected to a relatively high-G launch acceleration during which the reserve accelerometer must not be activated to protect its sensitive transducer, following which the UAV is only subjected to a maximum of 1-2 G accelerations and decelerations, during which the reserve accelerometer must be activated to accurately measure acceleration for guidance and control purposes. The UAV would then be subjected to other missions, during each mission cycle, the transducer must be similarly corrected, i.e., the reserve accelerometer must be in its pre-activation state and be activated following launch. This means that the reserve accelerometer must be resettable after each such mission. The method of designing such a resettable reserve linear accelerometer is herein described by an example of its application, indicated as the seventh reserve linear accelerometer embodiment 160 of the present invention.

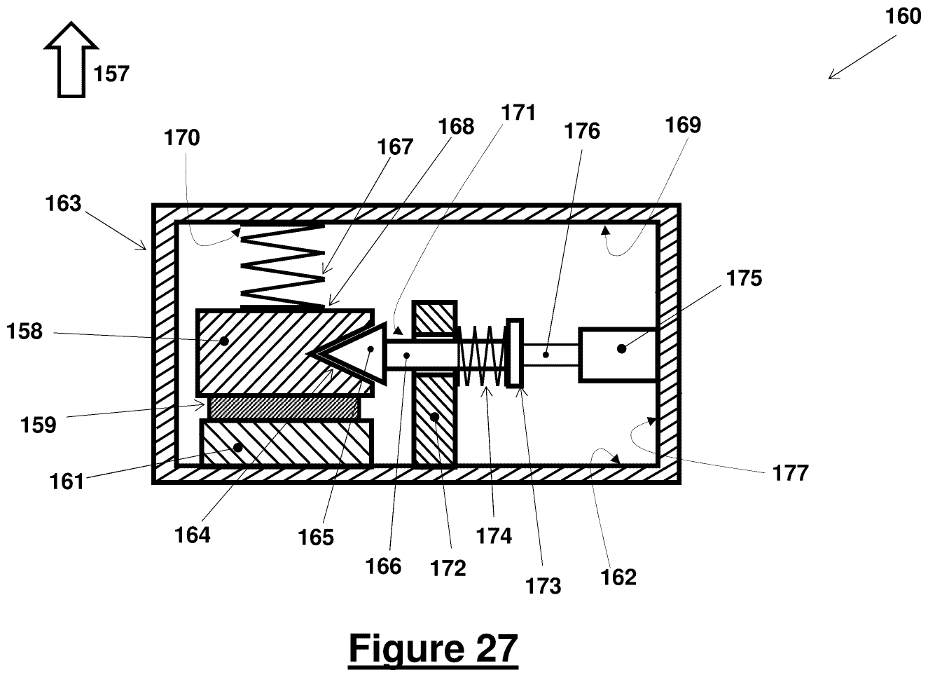

FIG. 27 illustrates the cross-sectional view of the seventh embodiment of a high-accuracy piezoelectric-based tension/compression type linear reserve accelerometer of the present invention, which is hereinafter referred to as the “reserve linear accelerometer” embodiment 160 of the present invention. In the schematic of FIG. 27, the reserve linear accelerometer embodiment 160 is shown in its configuration before it is activated to begin accurate measurement of acceleration in the prescribed range of low-G measuring accelerations. This embodiment of the present invention is designed to be activated only if the reserve linear accelerometer is subjected to the prescribed “acceleration measuring range” in the direction of arrow 157.

As can be seen in FIG. 27, the reserve linear accelerometer embodiment 160 consists of “proof-mass” 158, which is fixedly attached to the top surface of the piezoelectric member (transducer) 159, which is in turn fixedly attached to a support member 161. The support member 161 is then fixedly attached to the inside surface 162 of the reserve accelerometer housing 163. The piezoelectric member 159 is usually attached to the support member 161 and the proof-mass 158 using commonly used adhesives, usually of epoxy type or the like. The piezoelectric member 159 is polarized to measure compressive and tensile forces parallel to the direction of the arrow 157, which is the direction of the prescribed acceleration that the reserve accelerometer is designed to measure.

The proof-mass 158 is also provided with “V” shaped groove 164 that is used to engage with a mating “V” shaped section 165 of the release member 166 as shown in the cross-sectional view of FIG. 27. A preloaded compressive spring 167 is also provided that is attached to the top surface of the proof-mass 158 on one end 168 and to the top interior surface 169 of the reserve accelerometer housing 163 on the other end 170.

As can be seen in FIG. 27, the release member 166 is free to displace in guide 171, which is provided in the support member 172. The support member 172 is fixedly attached to the surface 162 of the reserve linear accelerometer housing 163. The release member 166 is also provided with an end piece 173, between which and the support member 172 is provided a preloaded compressive spring 174. In the schematic of FIG. 27 the provided electrically activated solenoid 175 is shown to have displaced the end piece 173 of the release member 166 forward by its piston 176 to overcome the compressive spring 174 force and fully engage its “V” shaped section 165 with the matching “V” shaped groove 164 of the proof-mass 158. The electrically actuated solenoid 175 is fixedly attached to the inner surface 177 of the reserve linear accelerometer housing 163.

In the illustrated pre-activation configuration of the reserve linear accelerometer embodiment 130 of FIG. 27, the “V” shaped section 165 of the release member 166 is shown to be fully engaged with the “V” shaped groove 164 of the proof-mass 158. In general, the angle of the “V” shaped mating tip and groove are selected to be relatively small, e.g., around 20 degrees and sometimes even less, so that the release member 166 could support any force that is applied to the proof-mass 158 in the direction of the arrow 157, i.e., that it would support any inertial force due to the action of the acceleration or deceleration of the reserve accelerometer in the direction of the arrow 157 and that the generated inertial force is not passed to the piezoelectric transducer 159.

The reserve linear accelerometer embodiment 160 of FIG. 27 would then function as follows. Consider the configuration of the reserve linear accelerometer shown in FIG. 27. When the object to which the reserve linear accelerometer embodiment 160 is attached is accelerated in the direction of the arrow 157, the acceleration acts on the mass of the proof-mass 158 and as a result applies a downward inertial force to the proof-mass as viewed in FIG. 27. It is appreciated that if the acceleration was in the opposite direction of the arrow 157, the generated inertial force would act in the upward direction on the proof-mass 158.

Now, if the release member 166 is designed to be effectively rigid as compared to the flexibility of the piezoelectric member (transducers) 159 and its support member 161 in the direction parallel to the direction of the arrow 157, then the generated downward or upward inertial forces acting on the proof-mass 158 would be supported by the release member 166, FIG. 27. As a result, the reserve linear accelerometer embodiment 160 would effectively not respond to the applied acceleration in the direction of the arrow 157 or in its opposite direction, even if the applied acceleration is relatively high-G, i.e., significantly higher in its level as compared to the maximum level of the low-G prescribed acceleration measuring range for the reserve linear accelerometer.

Now if the level of the applied acceleration in the direction of the arrow 157 is at or lower than peak acceleration of the aforementioned prescribed “accelerometer measuring range”, the solenoid 175 is powered by the system using the reserve linear accelerometer 160, retracting the solenoid piston 176, thereby disengaging it from the end piece 173 of the release member 166.

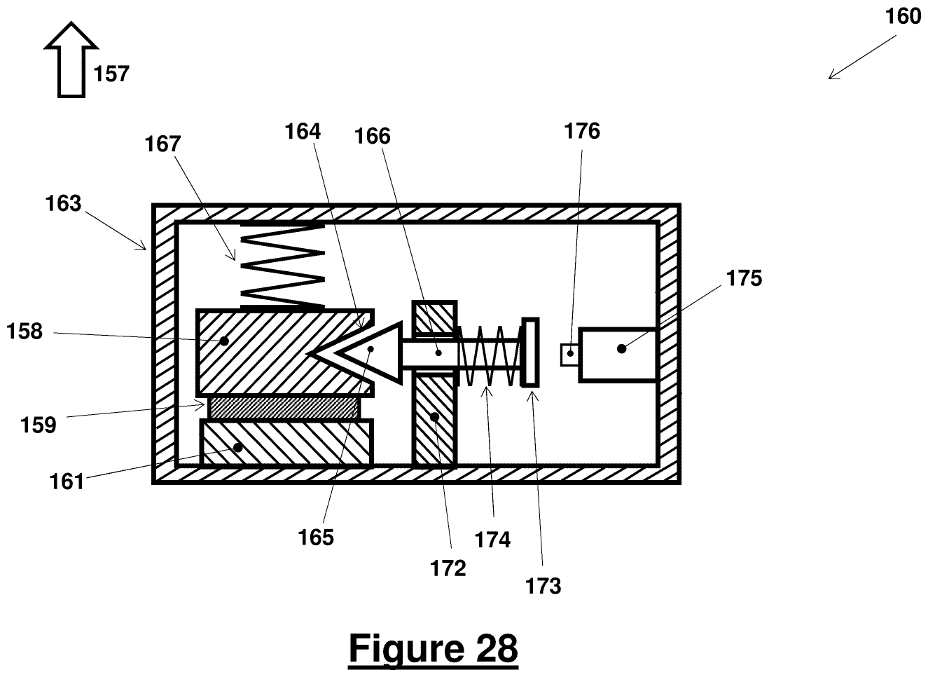

As a result, the preloaded compressive spring 174, FIG. 27, would force release member 166 to pull away from the proof-mass 158 and cause its “V” shaped section 165 to disengage the “V” shaped groove of the proof-mass 164 as shown in the schematic of FIG. 28. As a result, the proof-mass 158 is set free to respond to acceleration or deceleration in the direction of the arrow 157 and apply an inertial force proportional to the applied acceleration or deceleration to the piezoelectric member 159. The reserve linear accelerometer embodiment 160 would then perform its function of accurately measuring acceleration and deceleration in the direction of the arrow 157.

Now if the level of the applied acceleration in the direction of the arrow 157 is beyond the aforementioned prescribed “accelerometer measuring range”, then the solenoid 179 is not powered by the system using the reserve linear accelerometer embodiment 160, therefore the solenoid piston 176 is not retracted, thereby keeping the “V” shaped section 165 of the release member 166 engaged with the “V” shaped groove of the proof-mass 164, and the reserve linear accelerometer embodiment 160 is not activated.

As a result, if the level of the applied acceleration or deceleration in the direction of the arrow 157 is beyond the aforementioned prescribed “accelerometer measuring range”, then the reserve accelerometer embodiment 160 is not activated, which means that the piezoelectric member (transducer) of the reserve accelerometer is not subjected to high compressive (tensile) stress by the high-G applied acceleration (deceleration) in the direction of the arrow 157 acting on the proof-mass 158 of the reserve accelerometer, FIG. 27.

As a result, the proof-mass 158 of the reserve linear accelerometer embodiment 160 of FIG. 27 may be designed with relatively large mass, thereby allowing the reserve accelerometer to measure acceleration and deceleration in the direction of the arrow 157 in the prescribed range of low-G acceleration with very high accuracy.

It is appreciated that the preloading level of the preloaded compressive spring 167 is usually selected such that the piezoelectric member 159 is under compression in normal (no acceleration) conditions, so that the reserve linear accelerometer embodiment 160 can measure acceleration as well as deceleration in the direction of the arrow 157.

In an alternative construction of the reserve linear accelerometer embodiment 160 of FIGS. 27-28, the release member 166 is designed to have a certain amount of bending flexibility to allow for its deflection at its point of engagement with the proof-mass 158 groove 164 due to the generated inertial force by the proof-mass as the reserve accelerometer is accelerated or decelerated in the direction of the arrow 157. The release member 166 is however still constructed to be highly rigid in bending in the opposite direction.

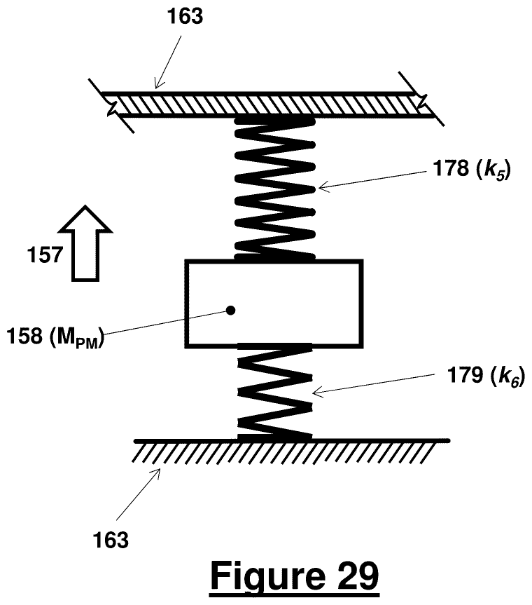

As a result, the release member 166 would effectively act as a spring element that is used to connect the proof-mass 158 to the structure of the housing 163 of the reserve linear accelerometer embodiment 160 as depicted in the model of FIG. 29.

It is appreciated by those skilled in the art, that all fabricated accelerometers such as all disclosed reserve accelerometers are generally calibrated before being used. In which case, all other structural flexibility, such as those associated with the accelerometer housing and other relevant components of the accelerometer are usually accounted for. In the structural model of FIG. 29, spring 178 with the spring rate k₅ is intended to represent the contributing bending flexibility of the release member 166 and the indicated possible relevant structural flexibilities of the reserve accelerometer embodiment 160.

In the structural model of FIG. 29, the spring 178 represents the equivalent bending flexibility of the release member 166 at the center of its “V” shaped tip 165 engagement with the “V” groove 164 of the proof-mass 158, and includes the flexibilities of other connecting elements between the reserve linear accelerometer housing 163 connection to the release member 166, the proof mass 158, etc., all in the direction of the arrow 157 as viewed in the schematic of FIG. 28, which would tend to result in a compressive or tensile strain of the piezoelectric member 159 in that direction. The spring 179 is intended to represent the flexibility of the piezoelectric member 159, which indicates the response (strain) of the reserve linear accelerometer embodiment 160 of FIGS. 27-28 to the applied acceleration or deceleration in the direction of the arrow 157.

It is appreciated by those skilled in the art that as can be seen from the structural model of FIG. 29, when the reserve linear accelerometer embodiment 160 of FIGS. 27-28 is accelerated or decelerated in the direction of the arrow 157, the acceleration (deceleration) acts on the effective mass of the proof-mass 158 and generate a proportional inertial force in the direction of the applied acceleration (deceleration). Now, if the effective mass of the proof-mass 158 is indicated as M_{PM}, and the spring rates of the springs 178 and 179 are indicated as k₅ and k₆, respectively, then by the application of an acceleration level a in the direction of the arrow 157, the proof-mass 158 is displaced a distance d_{PM} (in the direction of the applied acceleration) given by the following relationship:

$${d}_{PM} = {M}_{PM} a / ( {k}_{5} + {k}_{6} ) \qquad ( 3 )$$

It is appreciated that the distance d_{PM} in equation (3) corresponds to the applied longitudinal strain to the piezoelectric member 159, and that the effect of the spring rate k₅ is to reduce the longitudinal strain of the piezoelectric member 159 from the application of the acceleration in the direction of the arrow 157.

It is therefore appreciated by those skilled in the art that by providing a certain level of bending flexibility for the release member 166, the amount of longitudinal strain d_{PM} that is applied to the piezoelectric member 158 is controlled. This capability can then be used to provide the reserve linear accelerometer embodiment 160 of FIGS. 27-28 with the capability to measure the level of applied high-G accelerations or decelerations prior to the activation of the reserve linear accelerometer and to still very accurately measure the low-G accelerations and decelerations within the prescribed acceleration measuring range once the reserve accelerometer is activated as described below.

Consider the condition shown in FIG. 27 in which the reserve linear accelerometer embodiment 160 is not activated, i.e., the “V” shaped section 165 of the release member 166 is in engagement with the “V” shaped groove 164 of the proof-mass 158. The structural model of FIG. 29 describes the piezoelectric member (transducer) 158 strain as a result of acceleration or deceleration in the direction of the arrow 157 as given by equation (3). Now assume that the reserve linear accelerometer is expected to be subjected to high-G accelerations or decelerations in the direction of the arrow 157 and once it is activated, it is expected to very accurately measure acceleration or deceleration in the same direction. For example, if the high-G acceleration level is ±1000 G while the peak acceleration in the prescribed acceleration measuring range is 10 G, then by choosing a spring rate of k₅=99 k₆, the displacement (strain) d_{PM} that is applied to the piezoelectric member 159, FIG. 27, is reduced by a factor of 1/100 while the reserve accelerometer is not activated. As a result, even at peak acceleration of 1,000 G, the piezoelectric member 159 is subjected to only 10 G, which is not above its designed limit for low-G acceleration measurement.

The reserve linear accelerometer can therefore also measure the applied high-G acceleration and deceleration in the direction of the arrow 157 before its activation (obviously with less sensitivity than the prescribed low-G acceleration and deceleration measurement), but once activated, it would accurately measure acceleration within the prescribed acceleration measuring range.

It is appreciated by those skilled in the art that once the reserve linear accelerometer embodiment 160 has been activated as shown in FIG. 28, it can later be deactivated by actuation of the solenoid 175 and extension of the piston 176 to re-engage the “V” shaped section 165 of the release member 166 with the “V” shaped groove 164 of the proof-mass 158 as shown in FIG. 27. This capability is needed in certain applications in which the system in which the reserve accelerometer is mounted is subjected to intermittent high-G events, such as firing of rocket engines in munitions during the flight.

The above method of designing reserve accelerometer that are resettable after each mission of accurate low-G acceleration measurement may also be readily applied to shear type reserve linear accelerometers, such as to the reserve linear accelerometer embodiment 110 of FIGS. 17-20. A modified reserve linear accelerometer embodiment 110 is described below and is indicated as the eighth reserve linear accelerometer embodiment 180 of the present invention.

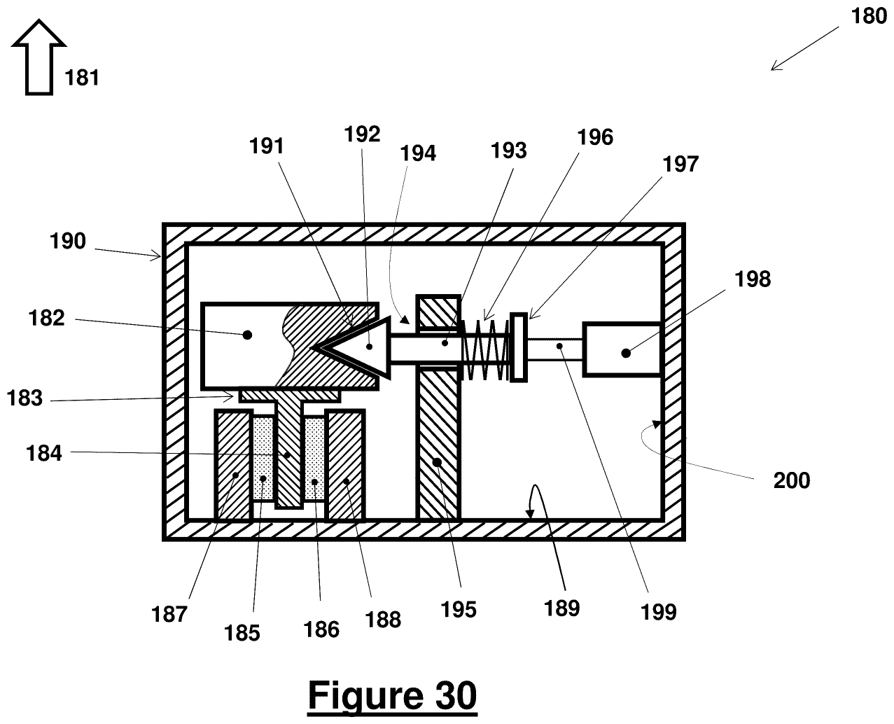

FIG. 30 illustrates the cross-sectional view of the eighth embodiment of a high-accuracy piezoelectric-based shear type linear reserve accelerometer of the present invention, which is hereinafter referred to as the “reserve linear accelerometer” embodiment 180 of the present invention. In the schematic of FIG. 30, the reserve linear accelerometer embodiment 180 is shown in its configuration before it is activated to begin accurate measurement of acceleration in the prescribed range of low-G measuring accelerations. This embodiment of the present invention is designed to be activated only if the reserve linear accelerometer is subjected to the prescribed “acceleration measuring range” in the direction of arrow 157. Following an activation event, the reserve linear accelerometer is reset to its initial (pre-activation) configuration and may undergo more than one activation and de-activation and resetting cycles.

As can be seen in FIG. 30, the reserve linear accelerometer embodiment 180 consists of “proof-mass” 182 (partially cross-section for clarity), which is fixedly attached to the top surface of the top section 183 of the “inertial force transmission member” 184. Pairs of piezoelectric elements (transducers) 185 and 186 are positioned between the support members 197 and 188 and the “inertial force transmission member” 184 as can be seen in FIG. 30. The pairs of piezoelectric elements 185 and 186 are generally attached to the support members 187 and 188 and the “inertial force transmission member” 184 surfaces using commonly used adhesives, usually of epoxy type or the like. The pairs of piezoelectric elements 185 and 186 may be arranged with vertical and/or horizontal polarization directions, whereby the same accelerometer can register motion in several directions perpendicular to one another. The support members 187 and 188 are fixedly attached to the bottom surface 189 of the reserve linear accelerometer housing 190.

The proof-mass 182 is also provided with “V” shaped groove 191, which is used to engage with a mating “V” shaped section 192 of the release member 193 as shown in the cross-sectional view of FIG. 30. As can be seen in FIG. 30, the release member 193 is free to displace in guide 194, which is provided in the support member 195. The support member 195 is fixedly attached to the surface 189 of the reserve linear accelerometer housing 190. The release member 193 is also provided with an end piece 197, between which and the support member 195 is provided a preloaded compressive spring 196. In the schematic of FIG. 30 the provided electrically activated solenoid 198 is shown to have displaced the end piece 197 of the release member 193 forward by its piston 199 to overcome the compressive spring 196 force and fully engage its “V” shaped section 192 with the matching “V” shaped groove 191 of the proof-mass 182. The electrically actuated solenoid 198 is fixedly attached to the inner surface 200 of the reserve linear accelerometer housing 190.

In the illustrated pre-activation configuration of the reserve linear accelerometer embodiment 180 of FIG. 30, the “V” shaped section 192 of the release member 193 is shown to be fully engaged with the “V” shaped groove 191 of the proof-mass 182. In general, the angle of the “V” shaped mating tip and groove are selected to be relatively small, e.g., around 20 degrees and sometimes even less, so that the release member 193 could support any force that is applied to the proof-mass 182 in the direction of the arrow 181, i.e., that it would support any inertial force due to the action of the acceleration or deceleration of the reserve accelerometer in the direction of the arrow 181 and that the generated inertial force is not passed to the pair of piezoelectric transducers 185 and 186.

The reserve linear accelerometer embodiment 180 of FIG. 30 would then function as follows. Consider the configuration of the reserve linear accelerometer shown in FIG. 30. When the object to which the reserve linear accelerometer embodiment 180 is attached is accelerated in the direction of the arrow 181, the acceleration acts on the mass of the proof-mass 182 and as a result applies a downward inertial force to the proof-mass 182 as viewed in FIG. 30. It is appreciated that if the acceleration was in the opposite direction of the arrow 181, the generated inertial force would act in the upward direction on the proof-mass 182.

Now, if the release member 193 is designed to be effectively rigid as compared to the shear flexibility of the piezoelectric members (transducers) 185 and 186 and its support members 187 and 188 in the direction parallel to the direction of the arrow 181, then the generated downward or upward inertial forces acting on the proof-mass 182 would be supported by the release member 193, FIG. 30. As a result, the reserve linear accelerometer embodiment 180 would effectively not respond to the applied acceleration in the direction of the arrow 181 or in its opposite direction, even if the applied acceleration is relatively high-G, i.e., significantly higher in its level as compared to the maximum level of the low-G prescribed acceleration measuring range for the reserve linear accelerometer.

Now if the level of the applied acceleration in the direction of the arrow 181 is at or lower than peak acceleration of the aforementioned prescribed “accelerometer measuring range”, the solenoid 198 is powered by the system using the reserve linear accelerometer 180, retracting the solenoid piston 199, thereby disengaging it from the end piece 197 of the release member 193.

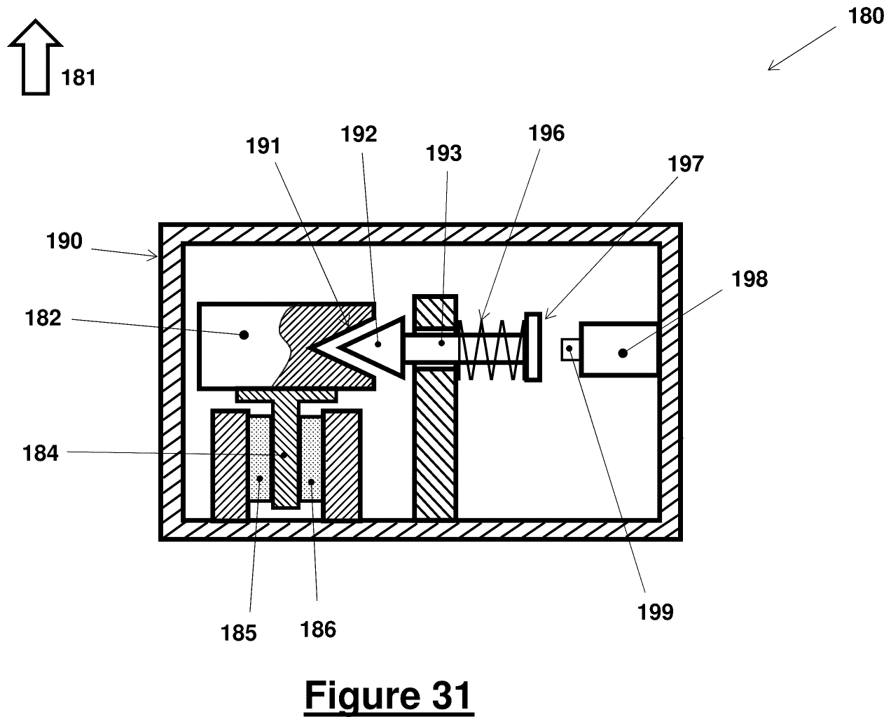

As a result, the preloaded compressive spring 196, FIG. 30, would force release member 193 to pull away from the proof-mass 182 and cause its “V” shaped section 192 to disengage the “V” shaped groove 191 of the proof-mass 182 as shown in the schematic of FIG. 31. As a result, the proof-mass 182 is set free to respond to acceleration or deceleration in the direction of the arrow 181 and apply a shearing inertial force proportional to the applied acceleration or deceleration to the piezoelectric members 185 and 186. The reserve linear accelerometer embodiment 180 would then perform its function of accurately measuring acceleration and deceleration in the direction of the arrow 181.

Now if the level of the applied acceleration in the direction of the arrow 181 is beyond the aforementioned prescribed “accelerometer measuring range”, then the solenoid 198 is not powered by the system using the reserve linear accelerometer embodiment 180, therefore the solenoid piston 199 is not retracted, thereby keeping the “V” shaped section 192 of the release member 193 engaged with the “V” shaped groove 191 of the proof-mass 182, and the reserve linear accelerometer embodiment 180 is not activated.

As a result, if the level of the applied acceleration or deceleration in the direction of the arrow 181 is beyond the aforementioned prescribed “accelerometer measuring range”, then the reserve accelerometer embodiment 180 is not activated, which means that the piezoelectric members (transducers) of the reserve accelerometer are not subjected to high shear stress by the high-G applied acceleration (deceleration) in the direction of the arrow 181 acting on the proof-mass 182 of the reserve accelerometer, FIG. 30.

As a result, the proof-mass 182 of the reserve linear accelerometer embodiment 180 of FIG. 30 may be designed with relatively large mass, thereby allowing the reserve accelerometer to measure acceleration and deceleration in the direction of the arrow 181 in the prescribed range of low-G acceleration with very high accuracy.

In an alternative construction of the reserve linear accelerometer embodiment 180 of FIGS. 30-31, similar to the reserve linear accelerometer embodiment 160 of FIGS. 27-28, the release member 193 (166 in FIG. 27) is designed to have a certain amount of bending flexibility to allow for its deflection at its point of engagement with the proof-mass 182 (158 in FIG. 27) groove 191 due to the generated inertial force by the proof-mass as the reserve accelerometer is accelerated or decelerated in the direction of the arrow 181 (157 in FIG. 27). The release member 193 is however still constructed to be highly rigid in bending in the opposite direction.

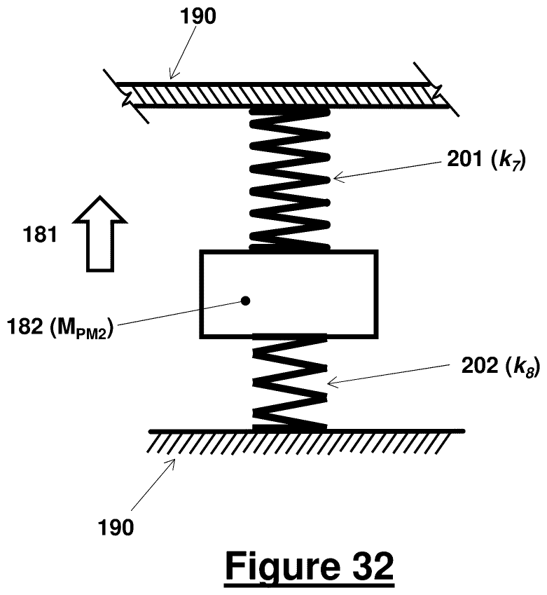

As a result, the release member 193 would effectively act as a spring element that is used to connect the proof-mass 182 to the structure of the housing 190 of the reserve linear accelerometer embodiment 180 as depicted in the model of FIG. 32.

It is appreciated by those skilled in the art, that all fabricated accelerometers such as all disclosed reserve accelerometers are generally calibrated before being used. In which case, all other structural flexibility, such as those associated with the accelerometer housing and other relevant components of the accelerometer are usually accounted for. In the structural model of FIG. 32, spring 201 with the spring rate k₇ is intended to represent the contributing bending flexibility of the release member 193 and the indicated possible relevant structural flexibilities of the reserve accelerometer embodiment 180.

In the structural model of FIG. 32, the spring 201 represents the equivalent bending flexibility of the release member 193 at the center of its “V” shaped tip 192 engagement with the “V” groove 191 of the proof-mass 182, and includes the flexibilities of other connecting elements between the reserve linear accelerometer housing 190 connection to the release member 193, the proof mass 182, etc., all in the direction of the arrow 181 as viewed in the schematic of FIG. 30, which would tend to result in a shear strain of the piezoelectric members 185 and 186 in that direction. The spring 202 is intended to represent the share flexibility of the piezoelectric members 185 and 186, which indicates the response (shear strain) of the reserve linear accelerometer embodiment 180 of FIGS. 30-31 to the applied acceleration or deceleration in the direction of the arrow 181.

It is appreciated by those skilled in the art that as can be seen from the structural model of FIG. 32, when the reserve linear accelerometer embodiment 180 of FIGS. 30-31 is accelerated or decelerated in the direction of the arrow 181, the acceleration (deceleration) acts on the effective mass of the proof-mass 182 and generate a proportional inertial force in the direction of the applied acceleration (deceleration). Now, if the effective mass of the proof-mass 182 is indicated as M_{PM2}, and the spring rates of the springs 201 and 202 are indicated as k₇ and k₈, respectively, then by the application of an acceleration level a in the direction of the arrow 181, the proof-mass 182 is displaced a distance d_{PM2} (in the direction of the applied acceleration) given by the following relationship:

$${d}_{PM 2} = {M}_{PM 2} a / ( {k}_{7} + {k}_{8} ) \qquad ( 4 )$$

It is appreciated that the distance d_{PM2} in equation (4) corresponds to the applied shear strain to the piezoelectric members 185 and 186, and that the effect of the spring rate k₇ is to reduce the shear strain of the piezoelectric members 185 and 186 from the application of the acceleration in the direction of the arrow 181.

It is therefore appreciated by those skilled in the art that by providing a certain level of bending flexibility for the release member 193, the amount of shear strain d_{PM2} that is applied to the piezoelectric members 185 and 186 is controlled. This capability can then be used to provide the reserve linear accelerometer embodiment 180 of FIGS. 30-31 with the capability to measure the level of applied high-G accelerations or decelerations prior to the activation of the reserve linear accelerometer and to still very accurately measure the low-G accelerations and decelerations within the prescribed acceleration measuring range once the reserve accelerometer is activated as described below.

Consider the condition shown in FIG. 30 in which the reserve linear accelerometer embodiment 180 is not activated, i.e., the “V” shaped section 192 of the release member 193 is in engagement with the “V” shaped groove 191 of the proof-mass 182. The structural model of FIG. 32 describes the shear strain of the piezoelectric members 185 and 186 as a result of acceleration or deceleration in the direction of the arrow 181 as given by equation (4). Now assume that the reserve linear accelerometer is expected to be subjected to high-G accelerations or decelerations in the direction of the arrow 181 and once it is activated, it is expected to very accurately measure acceleration or deceleration in the same direction. For example, if the high-G acceleration level is ±1000 G while the peak acceleration in the prescribed acceleration measuring range is 10 G, then by choosing a spring rate of k₇=99 k₈, the shear strain d_{PM2} that is applied to the piezoelectric members 185 and 186 is reduced by a factor of 1/100 while the reserve accelerometer is not activated. As a result, even at peak acceleration of 1,000 G, the piezoelectric members 185 and 186 are subjected to only 10 G, which is not above its designed limit for low-G acceleration measurement.

The reserve linear accelerometer can therefore also measure the applied high-G acceleration and deceleration in the direction of the arrow 181 before its activation (obviously with less sensitivity than the prescribed low-G acceleration and deceleration measurement), but once activated, it would accurately measure acceleration within the prescribed acceleration measuring range.

It is appreciated by those skilled in the art that once the reserve linear accelerometer embodiment 180 has been activated as shown in FIG. 31, it can later be deactivated by actuation of the solenoid 198 and extension of the piston 199 to re-engage the “V” shaped section 192 of the release member 193 with the “V” shaped groove 191 of the proof-mass 182 as shown in FIG. 30. This capability is needed in certain applications in which the system in which the reserve accelerometer is mounted is subjected to intermittent high-G events, such as firing of rocket engines in munitions during the flight.

It is noted that the reserve linear accelerometer embodiment 10 of FIGS. 1-4 is designed with a longitudinal pressure type piezoelectric transducer that converts its generated strain in the direction of the applied acceleration that is intended to be measured to a voltage that is detected by the accelerometer electronics. The reserve linear accelerometer embodiment 10 may, however, be readily modified and provided instead with shear type piezoelectric transducers, such as the piezoelectric member 84 and 85 and their assembly, FIG. 15, of the reserve linear accelerometer embodiment 80.

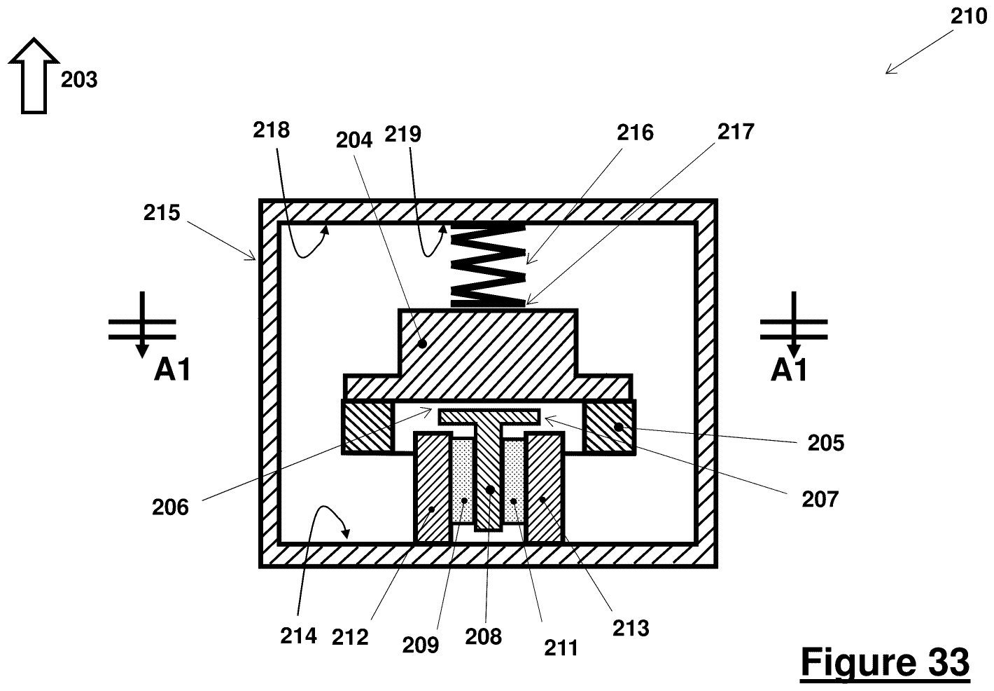

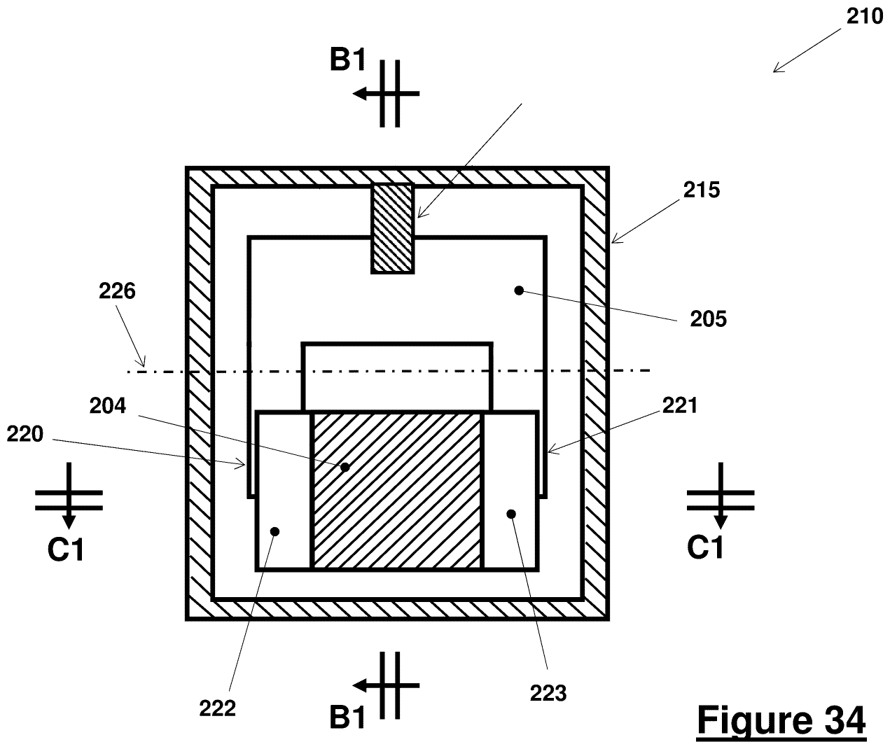

FIG. 33 illustrates the cross-sectional view C1-C1 of FIG. 34 of the nineth embodiment of a high-accuracy shear type piezoelectric-based reserve linear accelerometer of the present invention, which is hereinafter referred to as the “reserve linear accelerometer” embodiment 210 of the present invention. In the schematic of FIG. 33, the reserve linear accelerometer embodiment 210 is shown as it is subjected to a high-G acceleration in the direction of the arrow 203.

As can be seen in FIG. 33, the reserve linear accelerometer embodiment 210 consists of a “proof-mass” 204, which while the accelerometer is being subjected to a high-G acceleration level in the direction of the arrow 203, would be supported by the “High-G Support Member” 205, FIGS. 33-35. As it is described later, when the reserve linear accelerometer embodiment 210 is subjected to a high-G acceleration in the direction of the arow 203, the “high-G support member” 205 rises the proof-mass 204 up as viewed in the schematic of FIG. 33 to provide a gap 206 between the proof-mass 204 and the top section 207, FIG. 33, of the “inertial force transmission member” 208. The pairs of piezoelectric elements (transducers) 209 and 211 are positioned between the support members 212 and 213 and the “inertial force transmission member” 208 as can be seen in FIG. 33. The pairs of piezoelectric elements 209 and 211 are generally attached to the support members 212 and 213 and the “inertial force transmission member” 208 surfaces using commonly used adhesives, usually of epoxy type or the like. The pairs of piezoelectric elements 209 and 211 may be arranged with vertical and/or horizontal polarization directions, whereby the same accelerometer can register motion in several directions perpendicular to one another. The support members 212 and 213 are fixedly attached to the bottom surface 214 of the reserve linear accelerometer housing 215.

It is noted that the piezoelectric members 209 and 211 are polarized to function as shear transducers for measuring acceleration (deceleration) in the direction of arrow 203. In this configuration of the reserve linear accelerometer embodiment 210 of FIGS. 33-34, the proof-mass 204 is biased against the surface of the “high-G support member” 205 by the preloaded compressive spring 216. The preloaded compressive spring 216 is fixed to the top surface of the proof-mass 204 on one end 217 and to the inside surface 218 of the reserve linear accelerometer housing 215 on the other end 219.

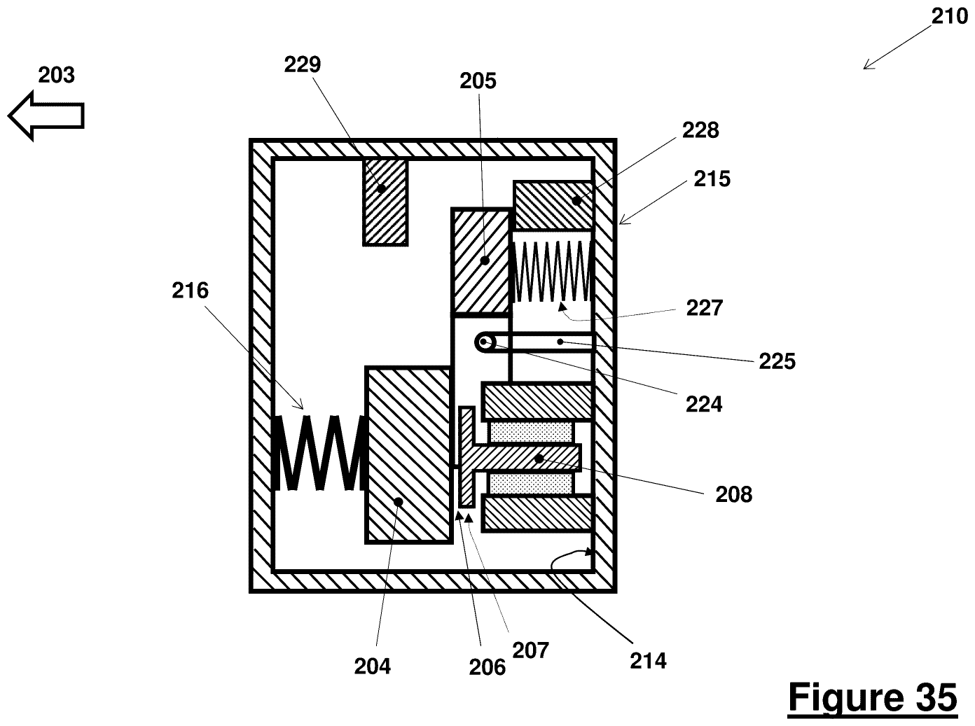

FIG. 34 shows the cross-sectional view A1-A1 of FIG. 33. As can be seen in FIG. 34, the “high-G support member” 205 is U-shaped with the sides 220 and 221 providing the means of supporting the sides 222 and 223 of the proof-mass 204, respectively, when the reserve linear accelerometer embodiment 210 is subjected to high-G accelerations as described later. The “high-G support member” 205 is attached to the housing 215 of the reserve linear accelerometer via a rotary joint 224, FIG. 35, with the shaft of the rotary joint passing from the side 220 of the “high-G support member” 205 to the side 221 being shown in the schematic of FIG. 34 by the centerline 226.

FIG. 35 shows the cross-sectional view B1-B1 of FIG. 34. As can be seen in FIG. 35, the “high-G support member” 205 is attached to the base surface 214 of the reserve linear accelerometer housing 215 by a rotary joint 224, via the support member 225. The reserve linear accelerometer embodiment 210 is also provided with the stop members 228 and 229, which are designed to limit counterclockwise and clockwise rotations, respectively, of the “high-G support member” 205. As can also be seen in the schematic of FIG. 35, in the illustrated configuration in which further clockwise rotation of the “high-G support member” 205 is prevented by the stop member 228, the proof-mass 204 is raised a small distance above the top section 207 of the “inertial force transmission member” 208 by the sides 220 and 221, FIG. 34, of the U-shaped “high-G support member” 205, thereby providing a small gap 206 between the proof-mass 204 and the top section 207 of the “inertial force transmission member”.

The reserve linear accelerometer embodiment 210 of FIGS. 33-35 would then function as follows, noting that in these illustrations, the reserve accelerometer is shown in the condition at which it is subjected to high-G acceleration in the direction of the arrow 203, which is defined as acceleration levels that are greater than the range of accelerations that the accelerometer is designed to accurately measure and referred to as the “acceleration measuring range”. It is also noted that hereinafter, the term acceleration is still intended to be used whether its magnitude is positive or negative, i.e., whether it indicates a positive or negative acceleration, i.e., whether it indicates acceleration or deceleration in the direction of the arrow 203.

Now while the object to which the reserve linear accelerometer embodiment 210 is attached is being accelerated in the direction of the arrow 203, FIGS. 33 and 35, the acceleration acts on the “high-G support member” 205, the center of mass of which is designed to be above the rotary joint 224 as viewed in the plane of FIG. 35, thereby generating a clockwise inertial torque that would tend to rotate the “high-G support member” 205 in the clockwise direction.

In the configuration of the reserve linear accelerometer shown in FIGS. 33-35, the level of the applied high-G acceleration in the direction of the arrow 203 is greater than the peak acceleration of the prescribed “acceleration measuring range”, and the “high-G support member” 205 and the preloaded compressive spring 227 are designed such that the generated clockwise inertial torque that is applied to the “high-G support member” 205 would overcome the preloading level of the preloaded compressive spring 227 and the combine force of the preloaded compressive spring 216 and the generated inertial force of the proof-mass 204. As a result, the clockwise rotation of the “high-G support member” 205 would cause its U-shaped sides 220 and 221 to raise the proof-mass 204 above the top section 207 of the “inertial force transmission member” 208 until its clockwise rotation is stopped by stop 228, leaving a gap 206 between proof-mass 204 and the top section 207 as shown in FIG. 35.

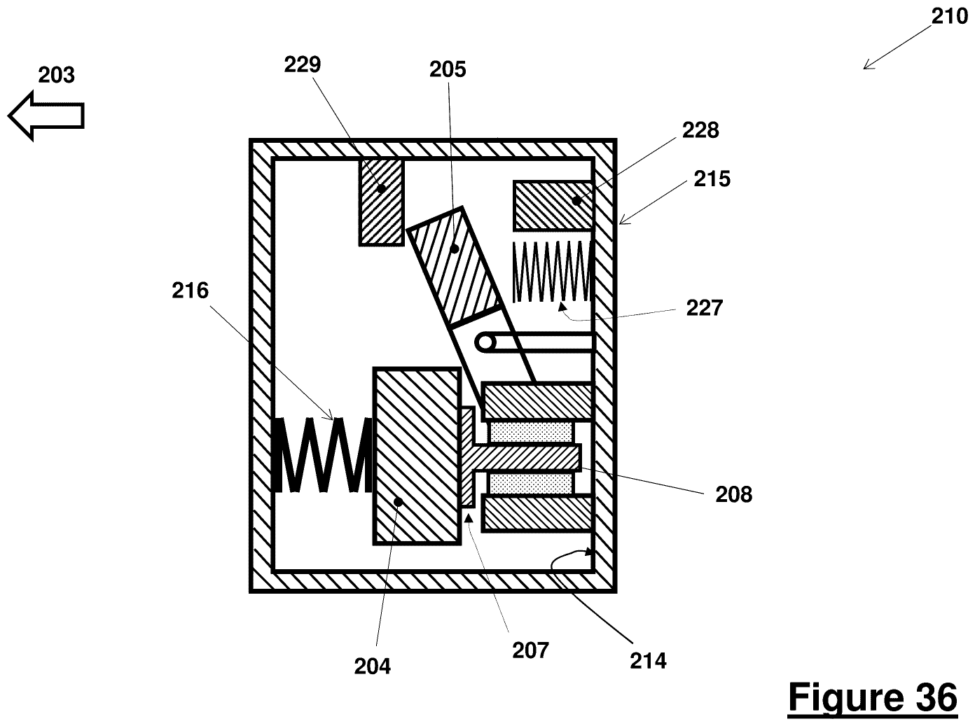

However, if the level of acceleration in the direction of the arrow 203 is less than or equal to the acceleration level that the accelerometer is designed to accurately measure, i.e., if it is less than or equal to the peak level of the “accelerometer measuring range”, then the preloaded compressive spring 227 is designed to force the “high-G support member” 205 to rotate in the counterclockwise direction, thereby causing the “high-G support member” 205 to disengage the proof-mass 204 as shown in the schematic of FIG. 36, resulting in the proof-mass 204 to be positioned over the top section 207 of the “inertial force transmission member” 208 by the preloaded compressive spring 216. The counterclockwise rotation of the “high-G support member” 205 may be limited by providing the stop 229, FIG. 36.

It is appreciated by those skilled in the art that the aforementioned “accelerometer measuring range” is intended to cover positive and negative acceleration in the direction of the arrow 203, i.e., both acceleration and deceleration in the direction of the arrow 203.

It is appreciated that the preloading level of the preloaded compressive spring 216 is usually selected so that the reserve linear accelerometer emarrow 210 could measure acceleration as well as deceleration in the direction of the arrow 203.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

What is claimed is:

1. An accelerometer comprising:
a housing;
a proof mass;
a piezoelectric material disposed in a movable range of the proof mass;
a support member for holding the proof mass a predetermined distance from the piezoelectric material, the proof mass being rotatably disposed relative to the housing and having a center of gravity offset from an axis of rotation of the support member;
a first biasing material for biasing the proof mass towards the piezoelectric material and against the support member; and
a second biasing material for biasing the proof mass at the predetermined distance from the piezoelectric material;
wherein when a level of acceleration of the proof mass is less than or equal to an acceleration level that is to be measured, the second biasing material is configured to force the support member to rotate to disengage the proof-mass and the first biasing material to move the proof-mass to contact the piezoelectric material.

2. The accelerometer of claim 1, wherein the support member having an end holding the proof mass, the end having a U-shape with first and second ends holding the proof mass.

3. The accelerometer of claim 2, wherein the proof mass having first and second projections corresponding to the first and second ends of the support member.

4. The accelerometer of claim 1, further comprising a first stop engaging the support member to limit an amount of the predetermined distance of the proof mass from the piezoelectric material.

5. The accelerometer of claim 4, further comprising a second stop engaging the support member for limiting a movement of the support member upon the level of the acceleration of the proof mass being less than or equal to the acceleration level that is to be measured.

6. The accelerometer of claim 1, wherein one or more of the first and second biasing materials being a helical spring.
